(19) United States
(12) Patent Application Publication
(10) Pub. No.: US 2021/0312404 A1
(43) Pub. Date: Oct. 7, 2021

(54) Device, Method, and Graphical User Interface for Changing the Time of a Calendar Event

(71) Applicant: Apple Inc., Cupertino, CA (US)

(72) Inventors: Cory Watson Bennett, Santa Clara, CA (US); Jeffrey D. Harris, Berkley, CA (US); Scott Joseph Adler, Saratoga, CA (US); Tara Faith Cates, Los Gatos, CA (US); Xu D. Chen, San Jose, CA (US)

(21) Appl. No.: 17/349,566

(22) Filed: Jun. 16, 2021

Related U.S. Application Data
(63) Continuation of application No. 15/609,649, filed on May 31, 2017.
(60) Provisional application No. 62/348,975, filed on Jun. 12, 2016.

(51) Int. Cl. G06Q 10/10; G06F 3/0486; H04L 12/58

(52) U.S. Cl. CPC G06Q 10/1095; G06Q 10/109; G06F 3/0482; H04L 51/22; H04L 51/24; G06F 3/0486

(57) ABSTRACT

In accordance with some embodiments, a method is performed at an invitee device with one or more processors, non-transitory memory, an input device, and a display. The method includes receiving, from an organizer, an invitation for a calendar event. The method includes displaying, on the display, a calendar user interface including a first graphical representation of the calendar event displayed at location of the calendar user interface corresponding to a time of the calendar event. The method includes detecting, via the input device, a proposed new time input indicative of a proposed new time for the calendar event. In response to detecting the proposed new time input, the method includes displaying a second graphical representation of the calendar event at a location of the calendar user interface corresponding to the proposed new time and sending a notification to the organizer including an indication of the proposed new time.

### CROSS-REFERENCE TO RELATED-APPLICATIONS

This application is a continuation application of and claims priority to U.S. patent application Ser. No. 15/609,649, filed on May 31, 2017, which claims priority to U.S. Provisional Patent App. No. 62/348,975, filed on Jun. 12, 2016, which are hereby incorporated by reference in their entirety.

### TECHNICAL FIELD

This relates generally to electronic devices with touch-sensitive surfaces, including but not limited to electronic devices with touch-sensitive surfaces that change a time of a calendar event.

### BACKGROUND

The use of touch-sensitive surfaces as input devices for computers and other electronic computing devices has increased significantly in recent years. Example touch-sensitive surfaces include touchpads and touch-screen displays. Such surfaces are widely used to manipulate user interface objects on a display.

Example manipulations include adjusting the position and/or size of one or more user interface objects or activating buttons or opening files/applications represented by user interface objects, as well as associating metadata with one or more user interface objects or otherwise manipulating user interfaces. Example user interface objects include digital images, video, text, icons, control elements such as buttons and other graphics. A user will, in some circumstances, need to perform such manipulations on user interface objects in a file management program (e.g., Finder from Apple Inc. of Cupertino, Calif.), an image management application (e.g., Aperture, iPhoto, Photos from Apple Inc. of Cupertino, Calif.), a digital content (e.g., videos and music) management application (e.g., iTunes from Apple Inc. of Cupertino, Calif.), a drawing application, a presentation application (e.g., Keynote from Apple Inc. of Cupertino, Calif.), a word processing application (e.g., Pages from Apple Inc. of Cupertino, Calif.), a website creation application (e.g., iWeb from Apple Inc. of Cupertino, Calif.), a disk authoring application (e.g., iDVD from Apple Inc. of Cupertino, Calif.), or a spreadsheet application (e.g., Numbers from Apple Inc. of Cupertino, Calif.).

A user will, in some circumstances, need to perform such manipulations on user interface objects in a calendar application (e.g., Calendar from Apple Inc. of Cupertino, Calif.). Such manipulations can include coordinating between multiple users to schedule an event.

### SUMMARY

However, methods for performing these manipulations are cumbersome and inefficient. For example, using a sequence of mouse based inputs to select one or more user interface objects and perform one or more actions on the selected user interface objects is tedious and creates a significant cognitive burden on a user. In addition, these methods take longer than necessary, thereby wasting energy. This latter consideration is particularly important in battery-operated devices.

Accordingly, there is a need for electronic devices with faster, more efficient methods and interfaces for changing the time of a calendar event. Such methods and interfaces optionally complement or replace conventional methods for changing the time of a calendar event. Such methods and interfaces reduce the cognitive burden on a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions are, optionally, included in a non-transitory computer readable storage medium or other computer program product configured for execution by one or more processors.

In accordance with some embodiments, a method is performed at a device with one or more processors, non-transitory memory, a display, and an input device. The method includes receiving, from an organizer, an invitation for a calendar event, displaying, on the display, a calendar user interface including a first graphical representation of the calendar event displayed at location of the calendar user interface corresponding to a time of the calendar event, detecting, via the input device, a proposed new time input indicative of a proposed new time for the calendar event, and in response to detecting the proposed new time input, displaying, on the display, a second graphical representation of the calendar event at a location of the calendar user interface corresponding to the proposed new time and sending a notification to the organizer including an indication of the proposed new time.

In accordance with some embodiments, a method is performed at a device with one or more processors, non-transitory memory, a display, and an input device. The method includes sending, to an invitee, an invitation for a calendar event, displaying, on the display, a calendar user interface including a first graphical representation of the calendar event displayed at a location of the calendar user interface corresponding to a time of the calendar event, receiving, from the invitee, a notification including an indication of a proposed new time for the calendar event, and, in response to receiving the notification, displaying, on the display, a proposed new time indicator in association with the first graphical representation.

In accordance with some embodiments, an electronic device includes a display unit configured to display a user interface, one or more input units configured to receive user inputs, and a processing unit coupled with the display unit and the one or more input units. The processing unit is configured to receive, from an organizer, an invitation for a calendar event, display, on the display unit, a calendar user interface including a first graphical representation of the calendar event displayed at location of the calendar user interface corresponding to a time of the calendar event, detect, via the one or more input units, a proposed new time input indicative of a proposed new time for the calendar event, and, in response to detecting the proposed new time input, display, on the display unit, a second graphical representation of the calendar event at a location of the calendar user interface corresponding to the proposed new time and send a notification to the organizer including an indication of the proposed new time.

In accordance with some embodiments, an electronic device includes a display unit configured to display a user interface, one or more input units configured to receive user inputs, and a processing unit coupled with the display unit and the one or more input units. The processing unit is configured to send, to an invitee, an invitation for a calendar event, display, on the display unit, a calendar user interface including a first graphical representation of the calendar event displayed at a location of the calendar user interface corresponding to a time of the calendar event, receiving, from the invitee, a notification including an indication of a proposed new time for the calendar event, and, in response to receiving the notification, display, on the display unit, a proposed new time indicator in association with the first graphical representation.

In accordance with some embodiments, an electronic device includes a display, an input device, one or more processors, non-transitory memory, and one or more programs; the one or more programs are stored in the non-transitory memory and configured to be executed by the one or more processors and the one or more programs include instructions for performing or causing performance of the operations of any of the methods described herein. In accordance with some embodiments, a non-transitory computer readable storage medium has stored therein instructions which when executed by one or more processors of an electronic device with a display and an input device, cause the device to perform or cause performance of the operations of any of the methods described herein. In accordance with some embodiments, a graphical user interface on an electronic device with a display, an input device, a memory, and one or more processors to execute one or more programs stored in the non-transitory memory includes one or more of the elements displayed in any of the methods described above, which are updated in response to inputs, as described in any of the methods described herein. In accordance with some embodiments, an electronic device includes: a display, an input device; and means for performing or causing performance of the operations of any of the methods described herein. In accordance with some embodiments, an information processing apparatus, for use in an electronic device with a display and an input device, includes means for performing or causing performance of the operations of any of the methods described herein.

Thus, electronic devices with displays, touch-sensitive surfaces and optionally one or more sensors to detect intensity of contacts with the touch-sensitive surface are provided with faster, more efficient methods and interfaces for changing the time of a calendar event, thereby increasing the effectiveness, efficiency, and user satisfaction with such devices. Such methods and interfaces may complement or replace conventional methods for changing the time of a calendar event.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5AF illustrate example user interfaces for changing the time of a calendar event in accordance with some embodiments.

FIGS. 6A-6D are flow diagrams illustrating a method of proposing a new time for an invited calendar event in accordance with some embodiments.

FIGS. 7A-7C are flow diagrams illustrating a method of changing the time of an organized calendar event in accordance with some embodiments.

FIGS. 8-9 are functional block diagrams of an electronic device in accordance with some embodiments.

### DESCRIPTION OF EMBODIMENTS

Scheduling events between two or more participants can be difficult. Thus, many electronic devices have graphical user interfaces with calendar applications to assist in scheduling and tracking such events, generating data structures (referred to herein as calendar events) that include metadata regarding events and can be shared (as invitations) and modified. Nevertheless, in some circumstances, an invitee can receive an invitation for a calendar event generated by an organizer and be unable to attend the underlying event at the time indicated in the invitation. Accordingly, in embodiments described below, an invitee can respond to an invitation by proposing a new time for the calendar event (and, thus, the event itself). In response to the proposal, the organizer can easily change the time of the calendar event to the proposed new time.

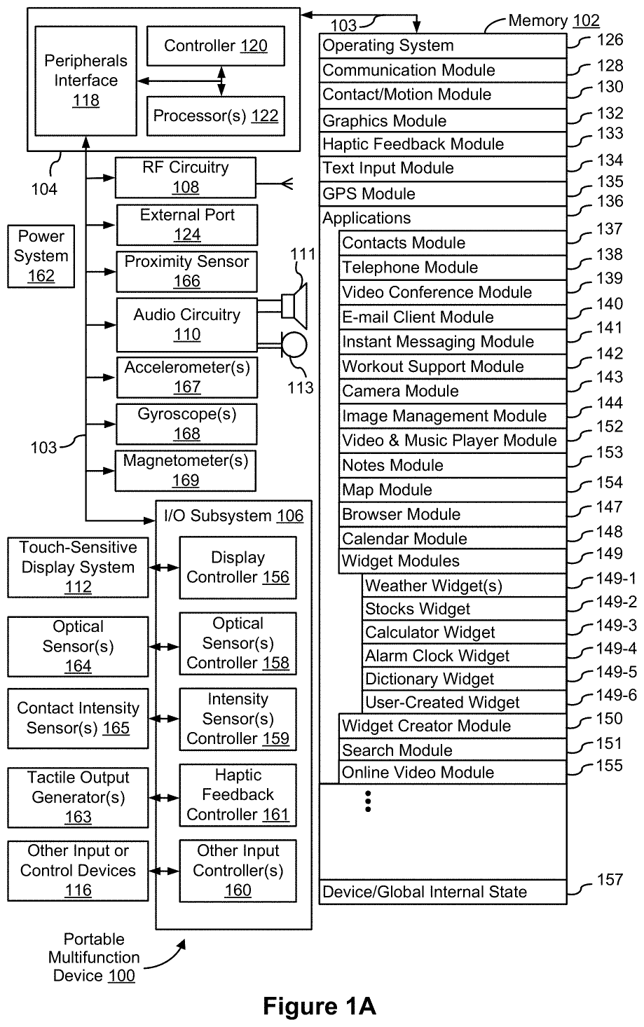

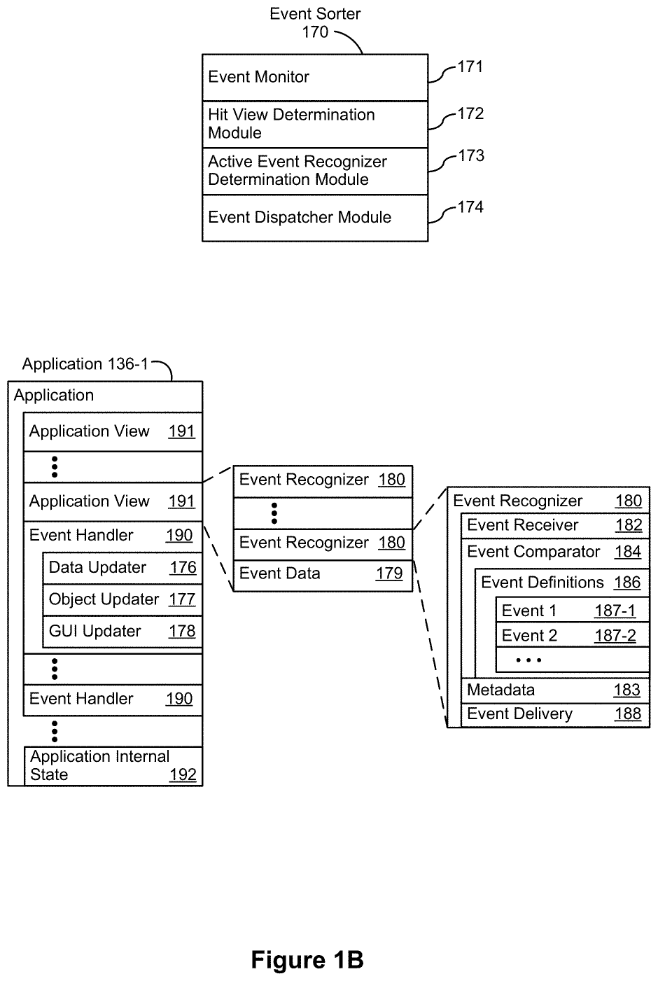

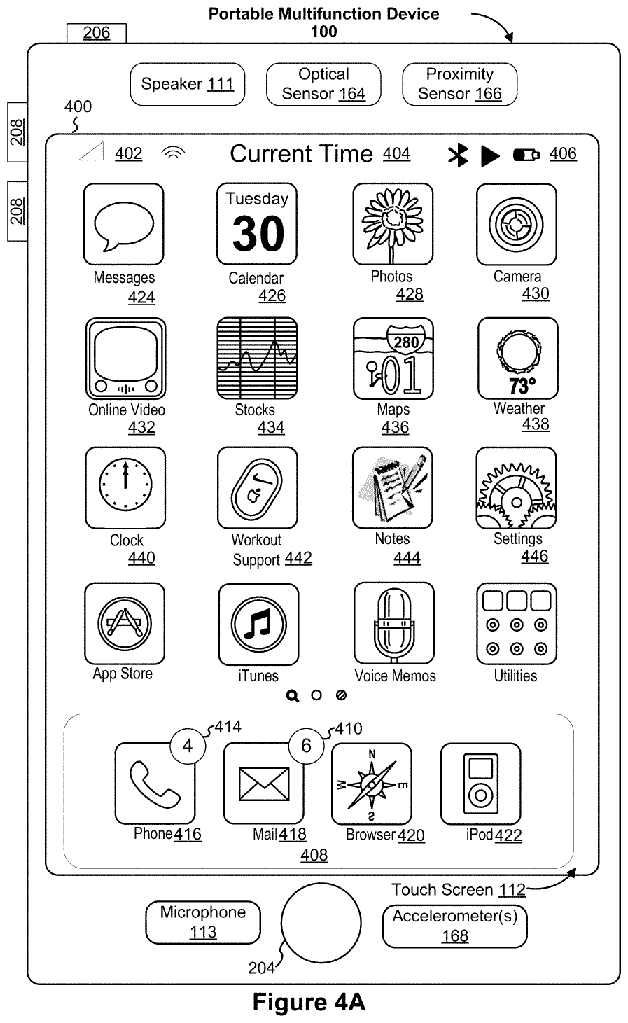

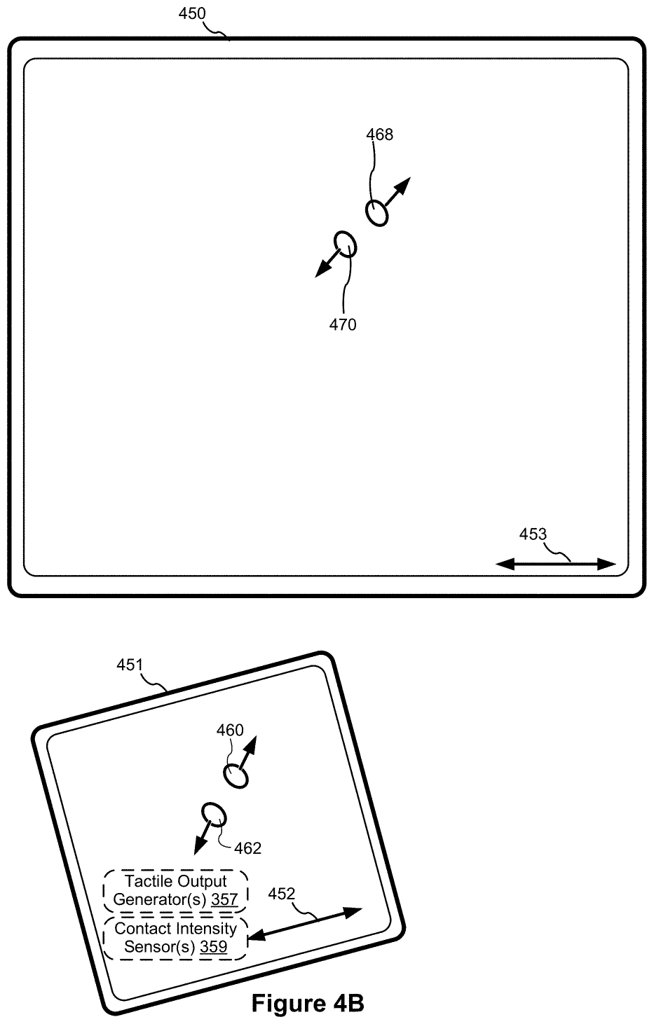

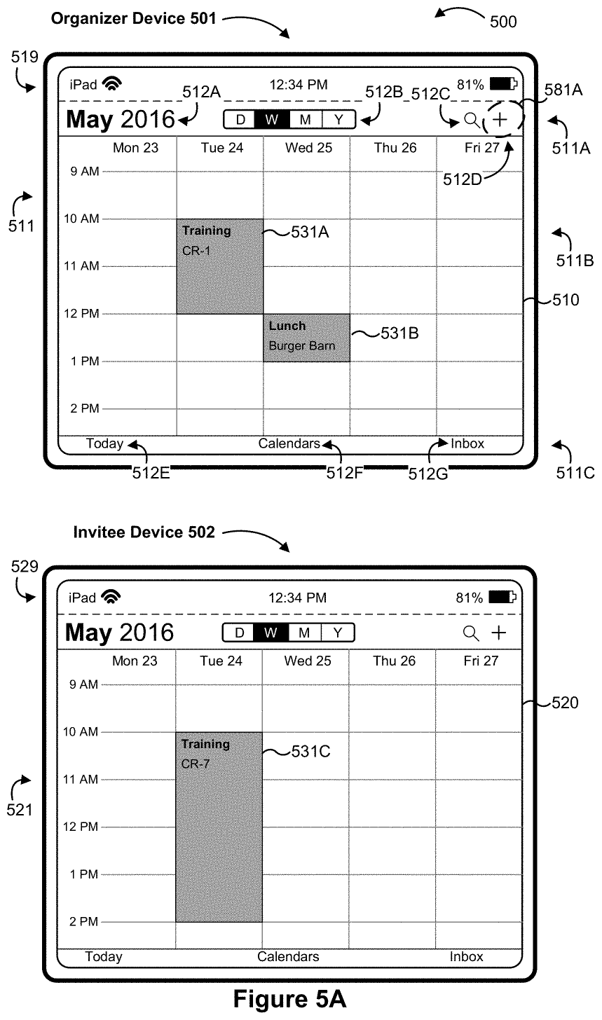

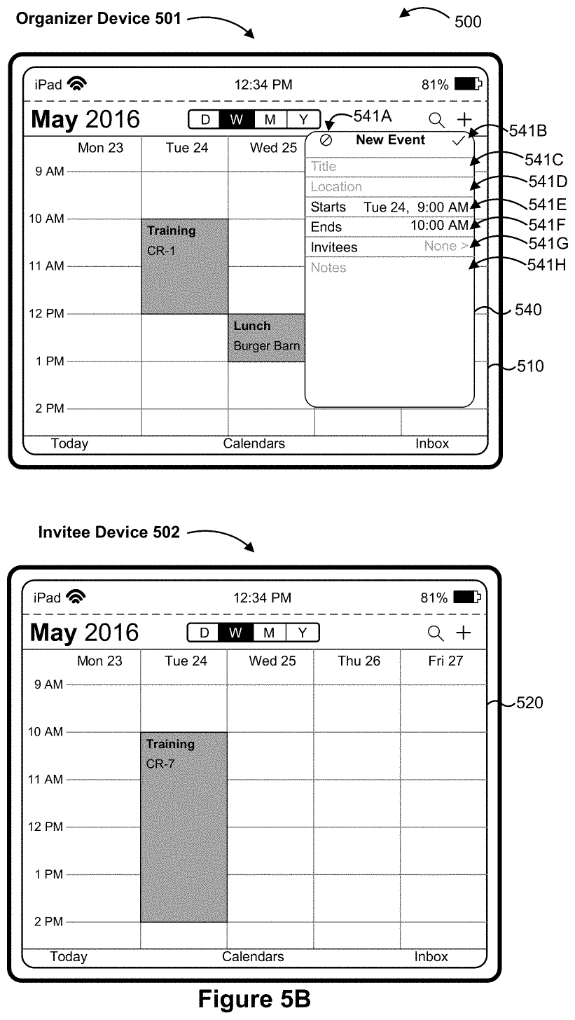

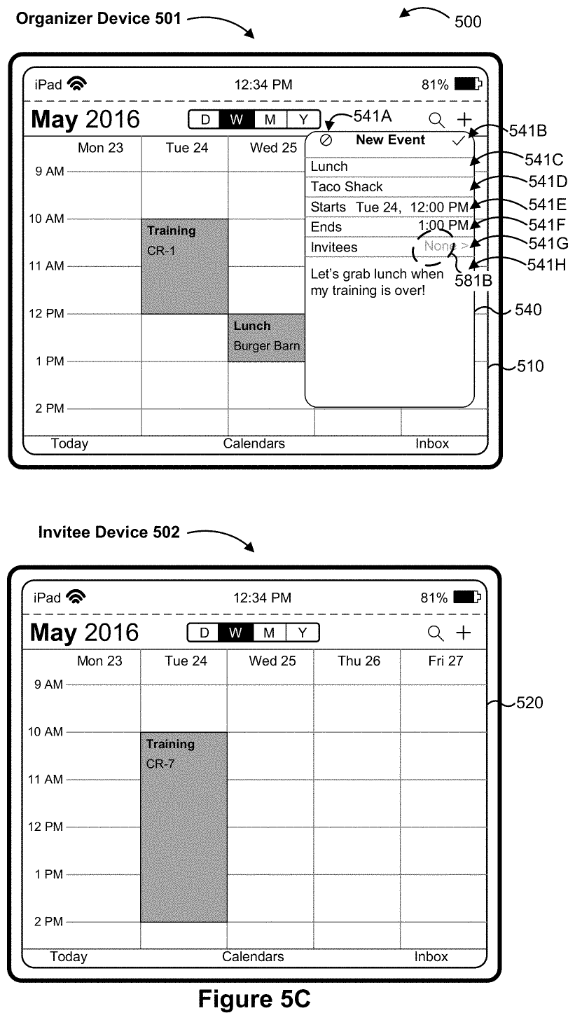

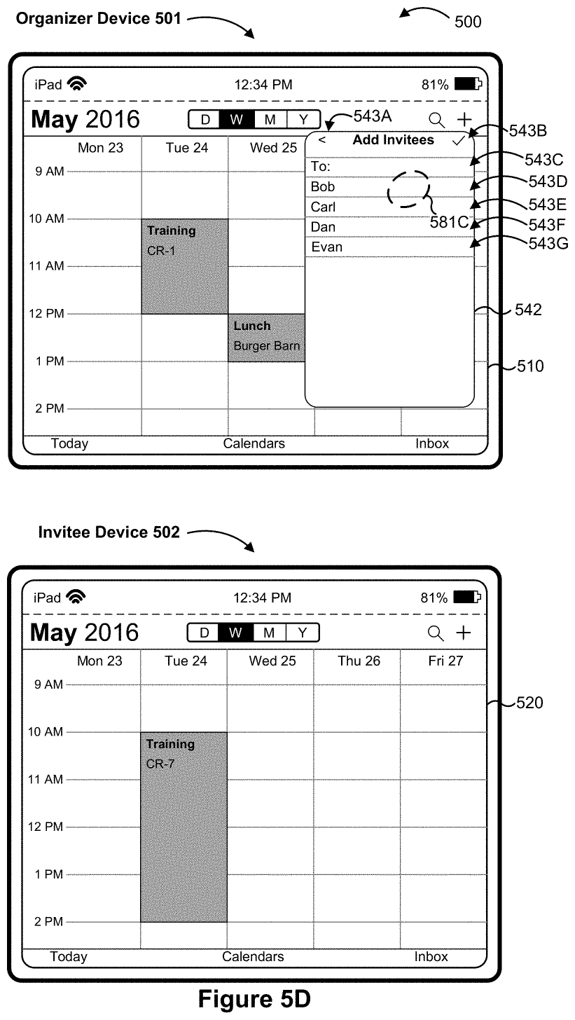

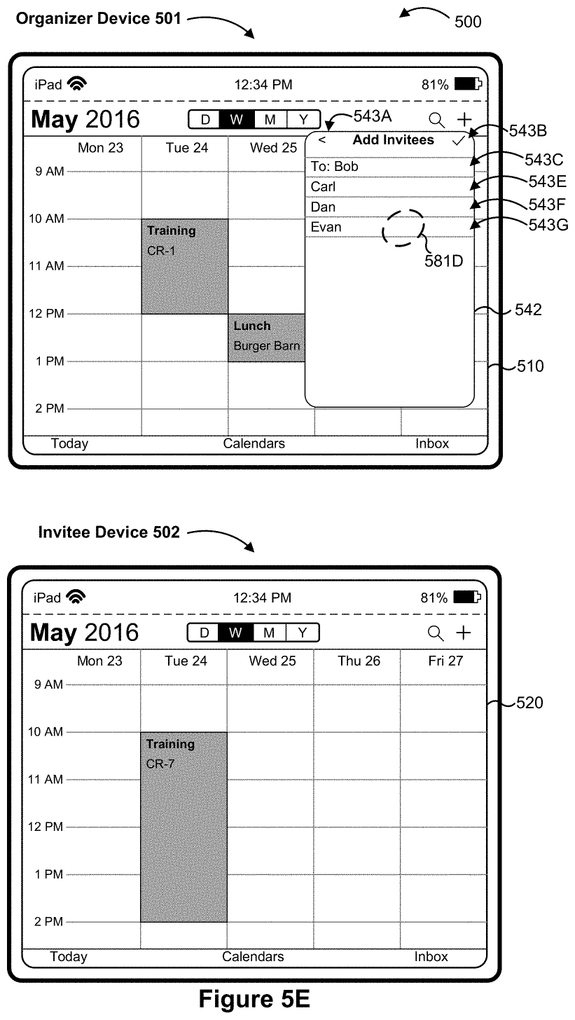

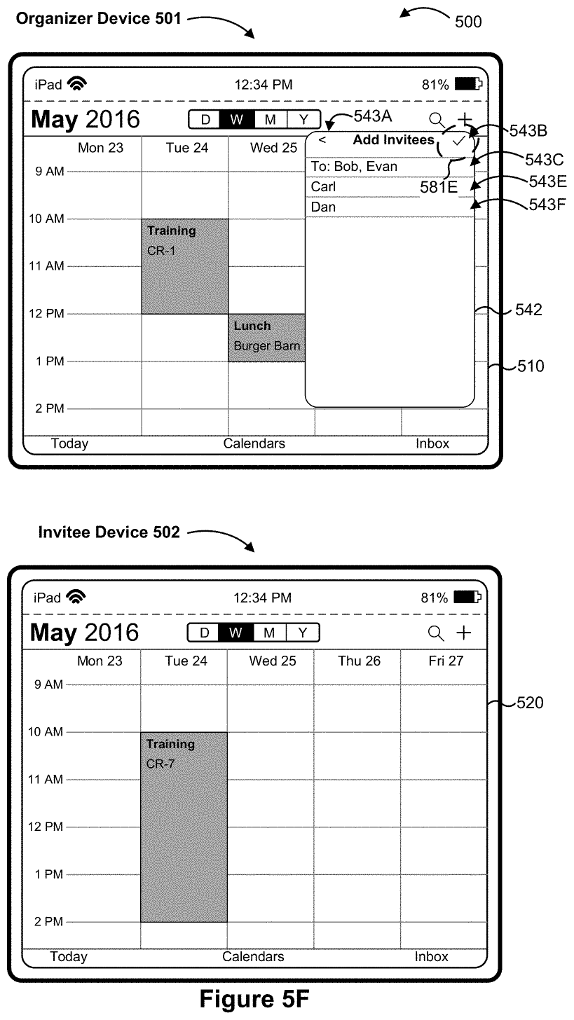

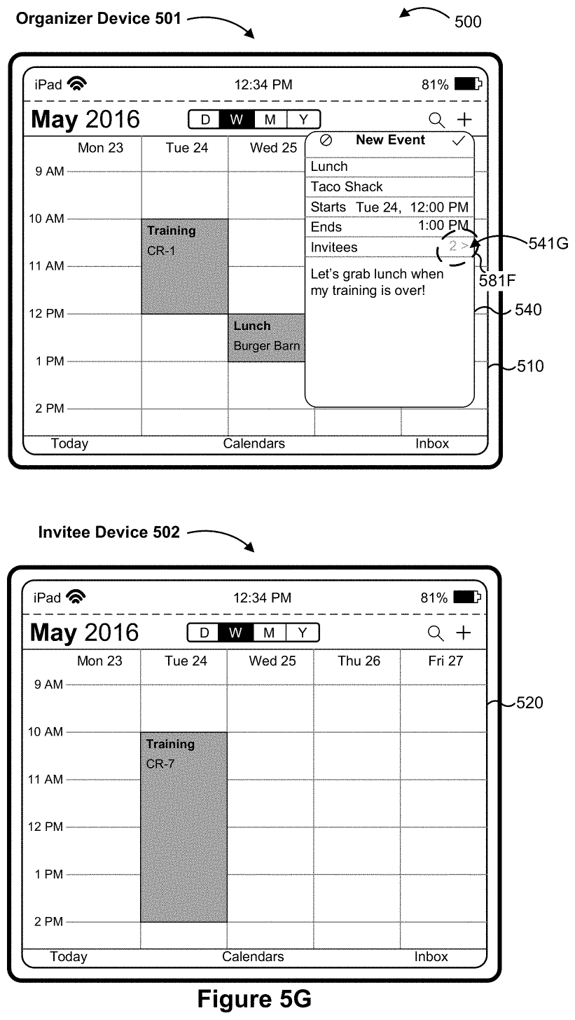

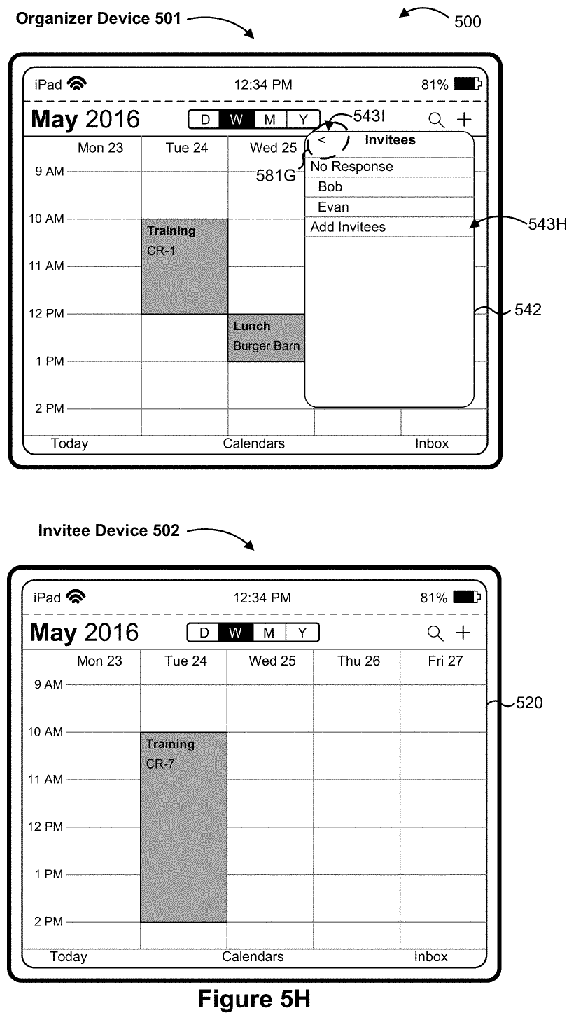

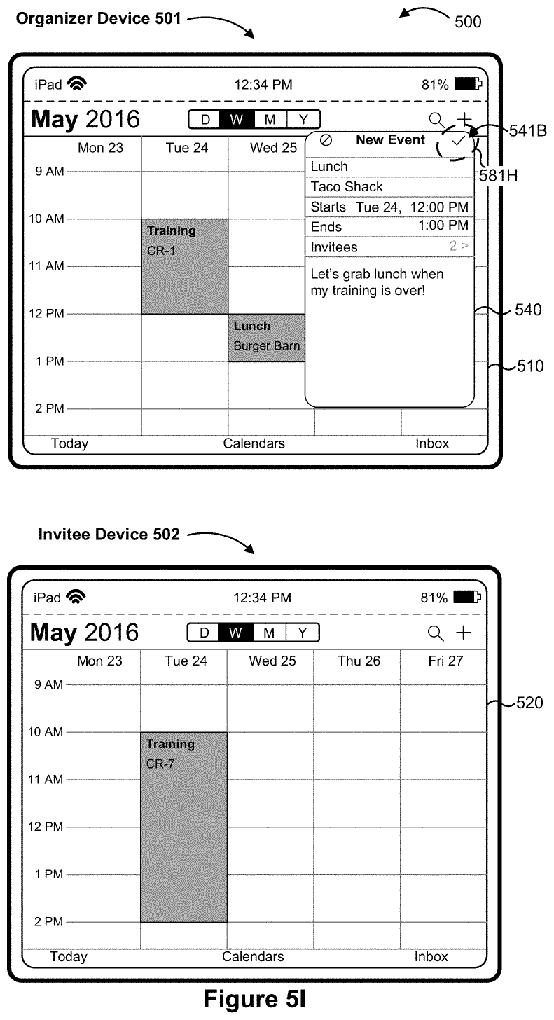

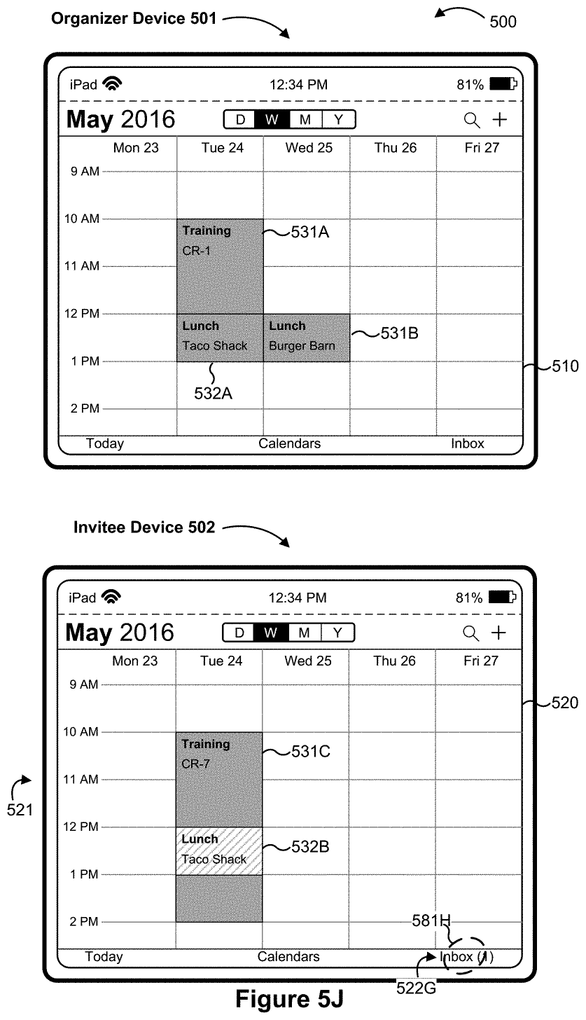

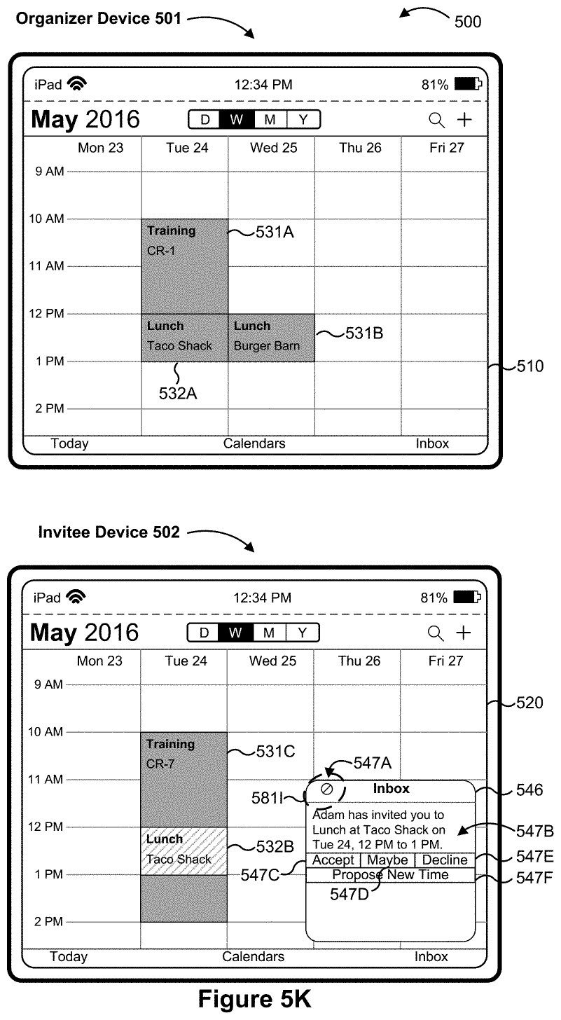

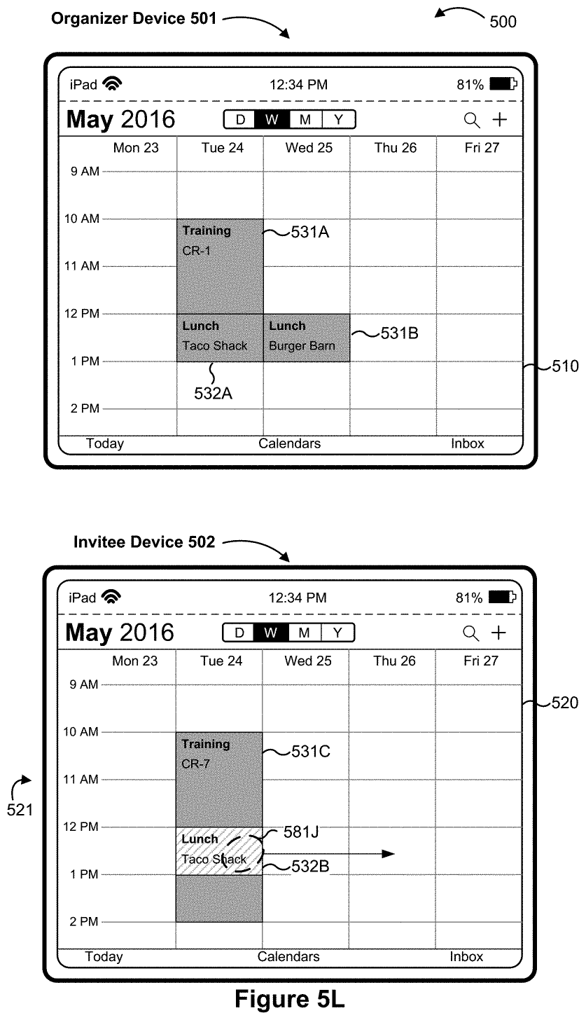

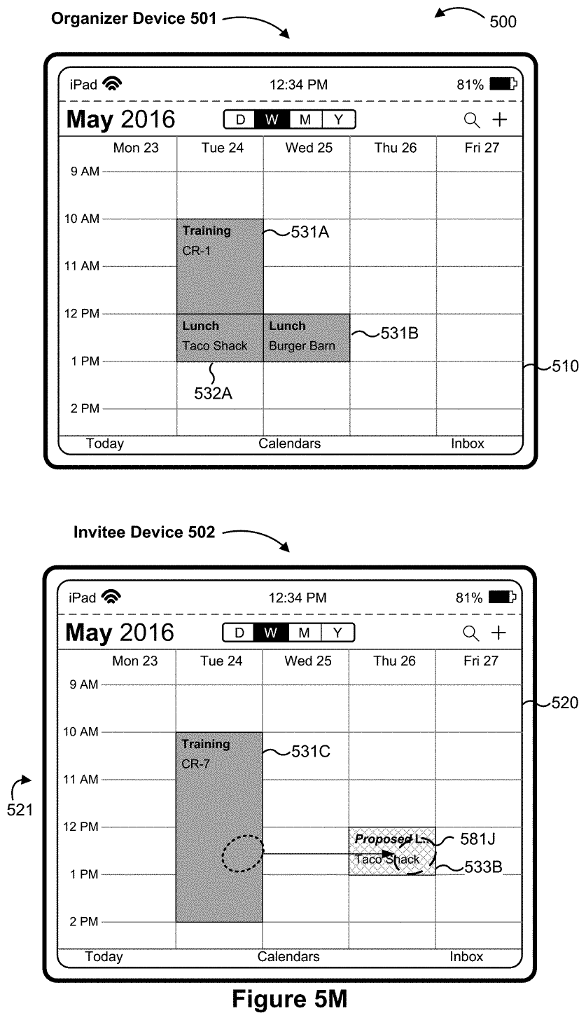

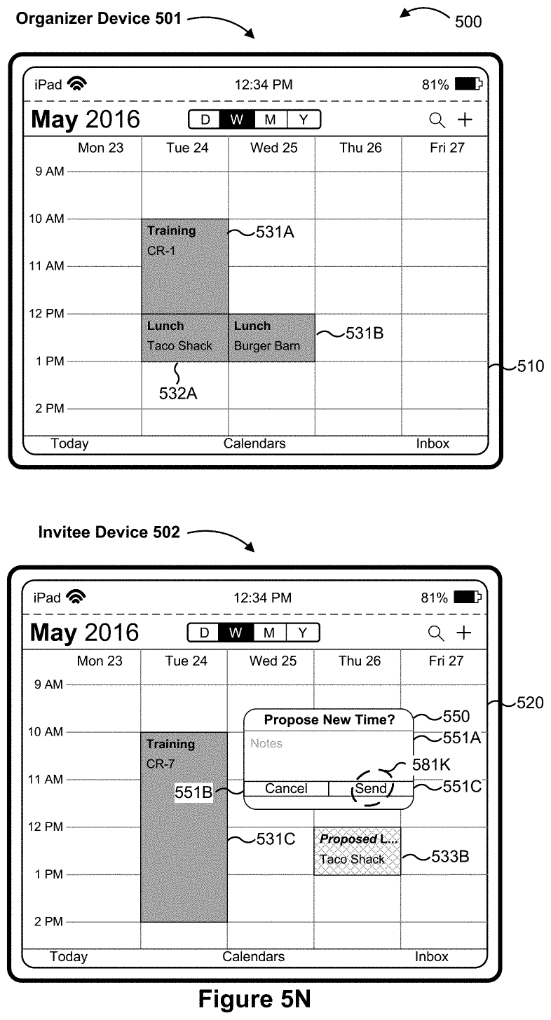

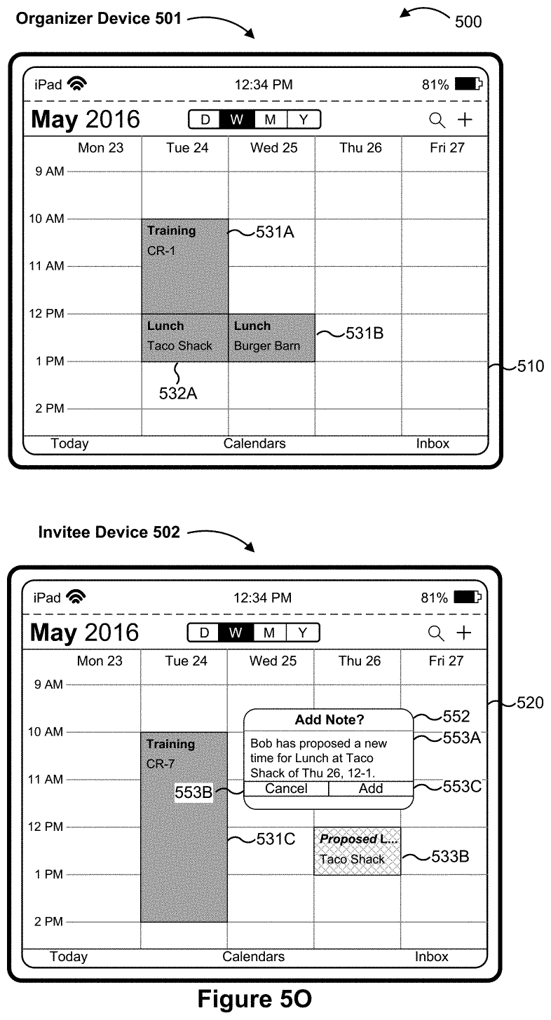

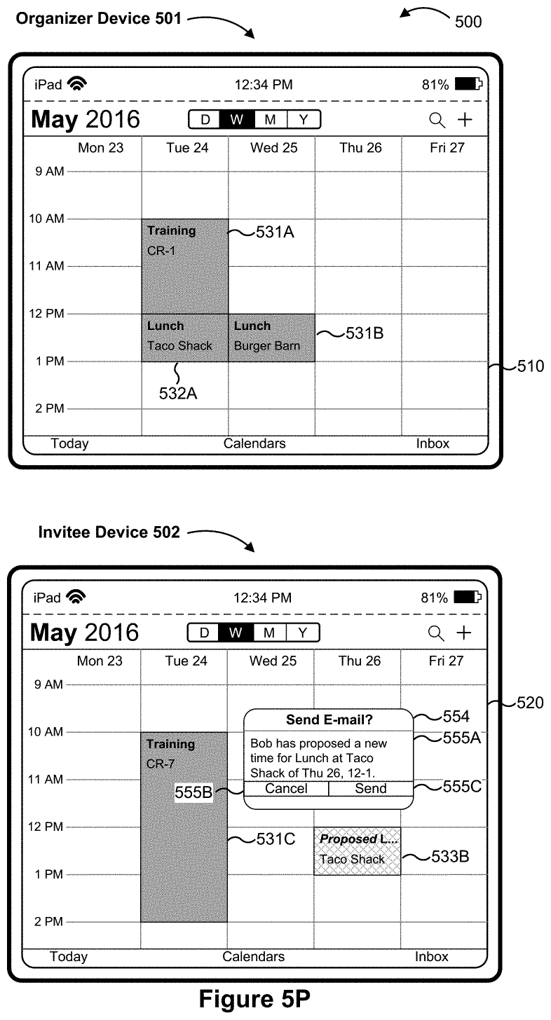

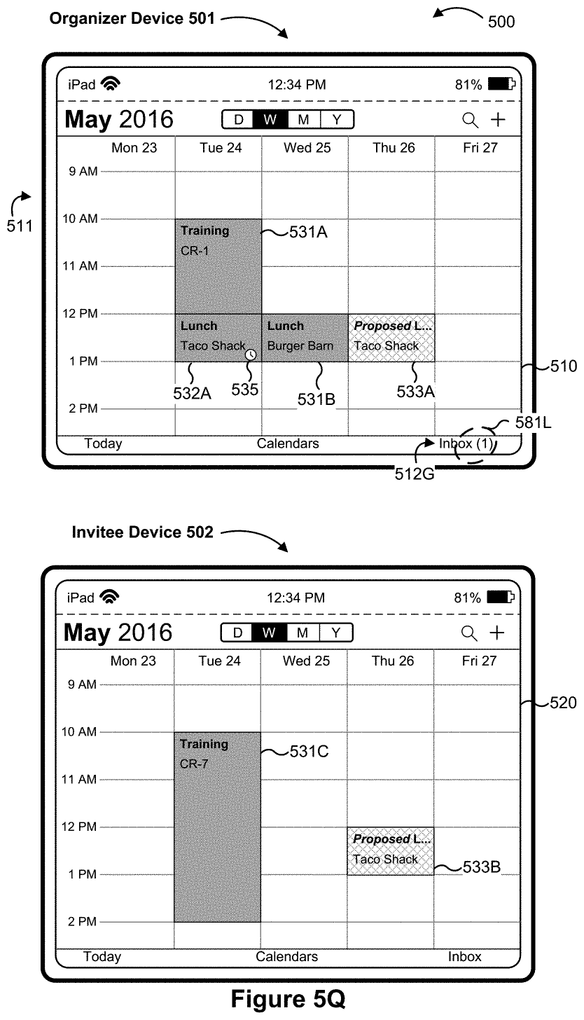

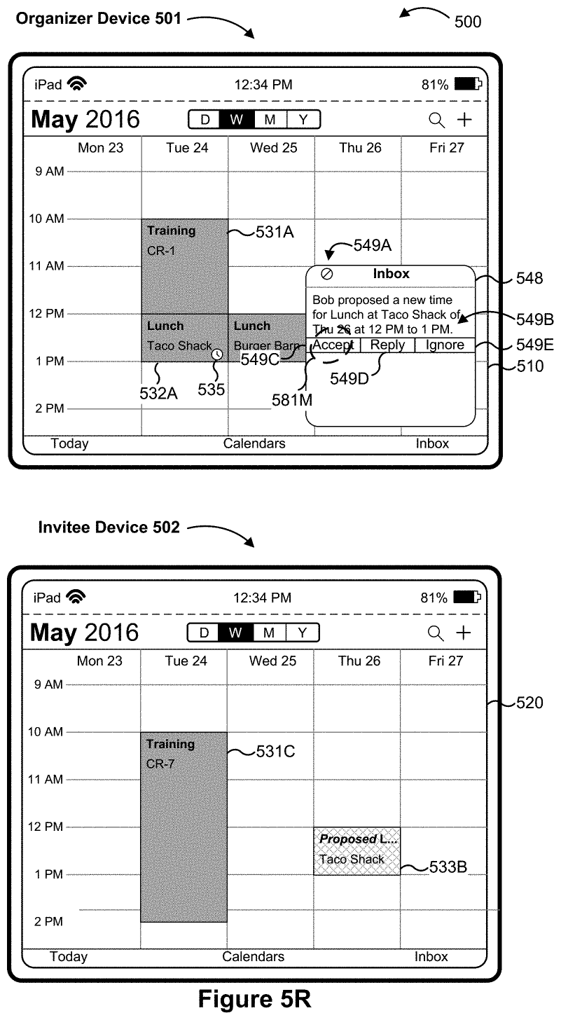

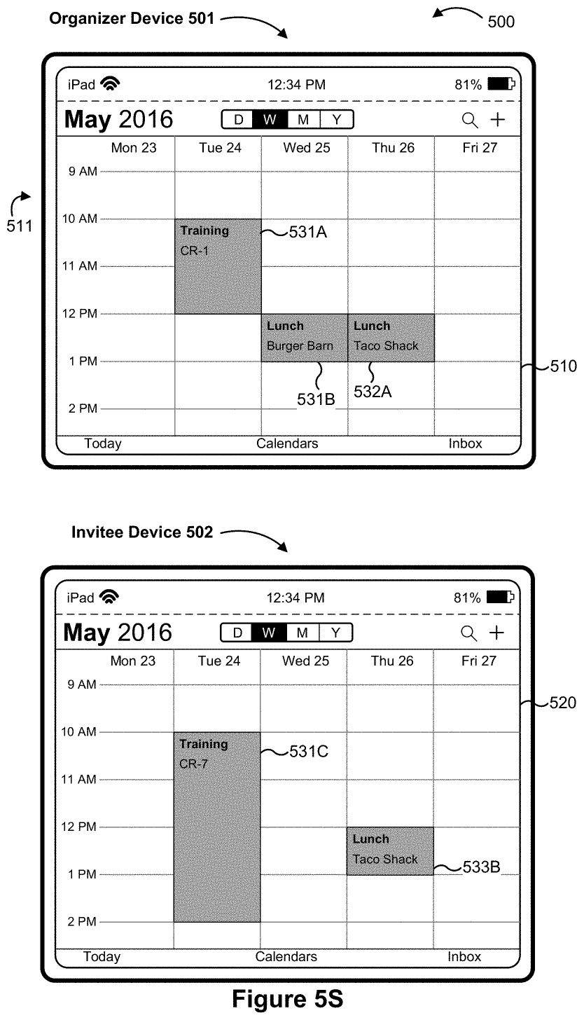

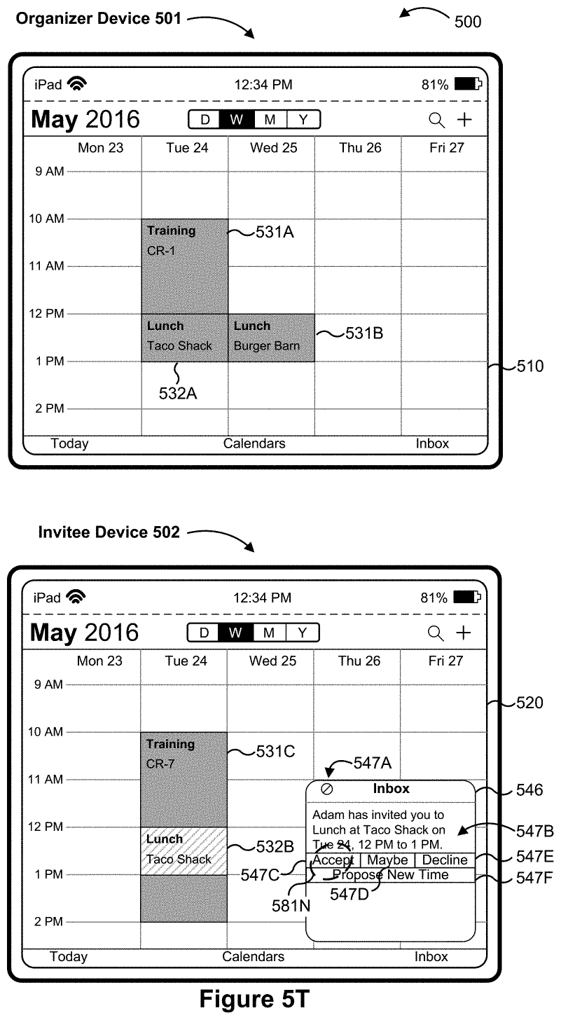

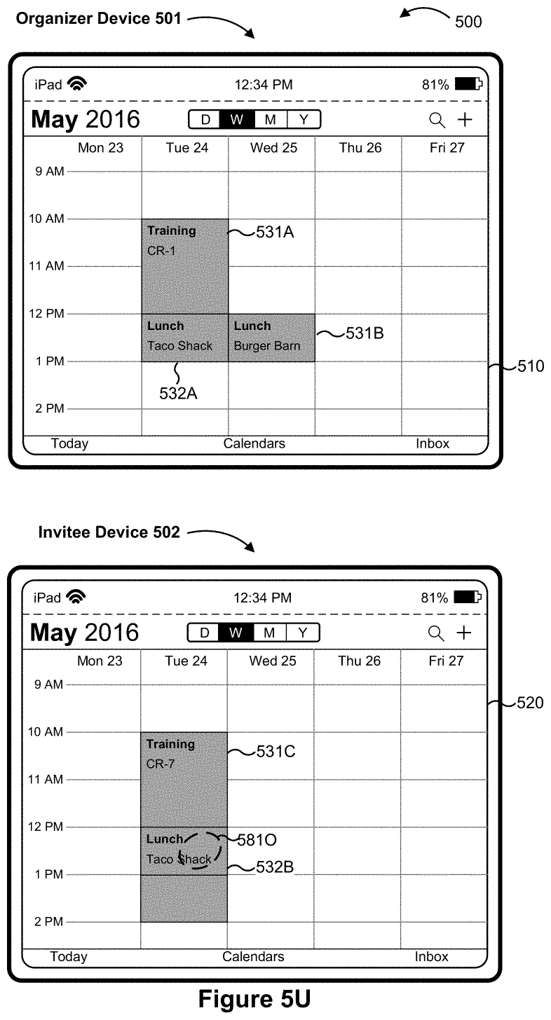

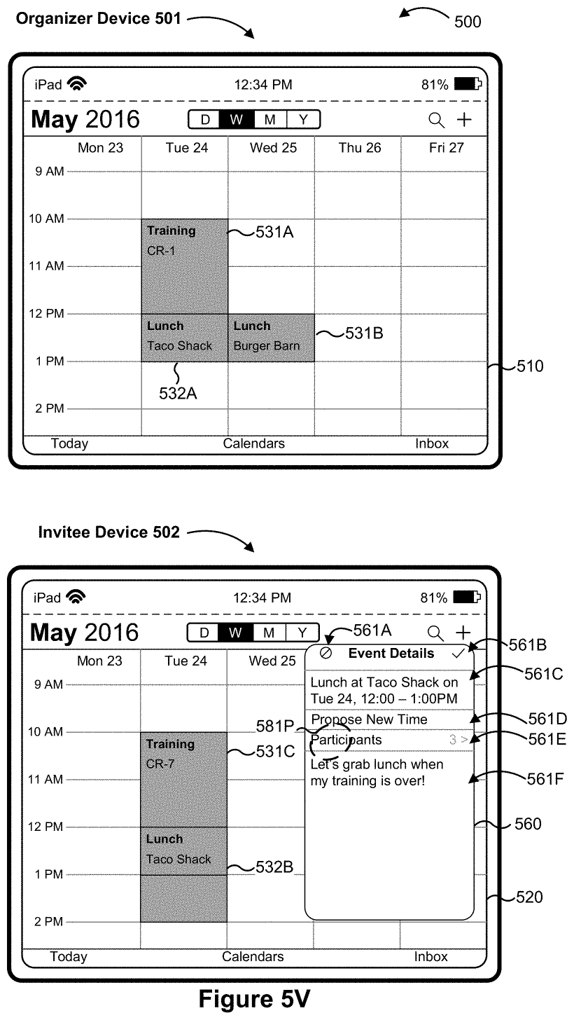

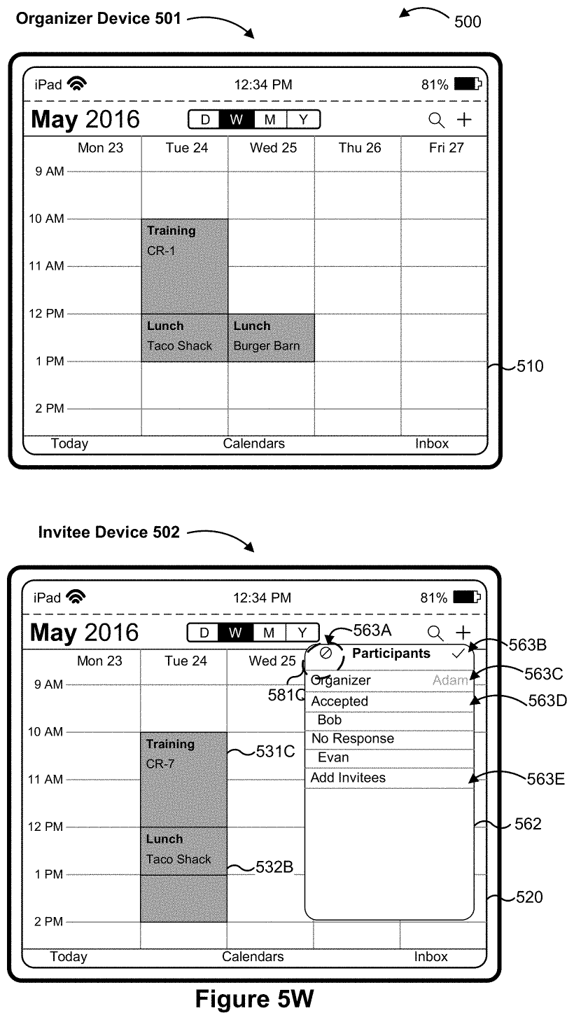

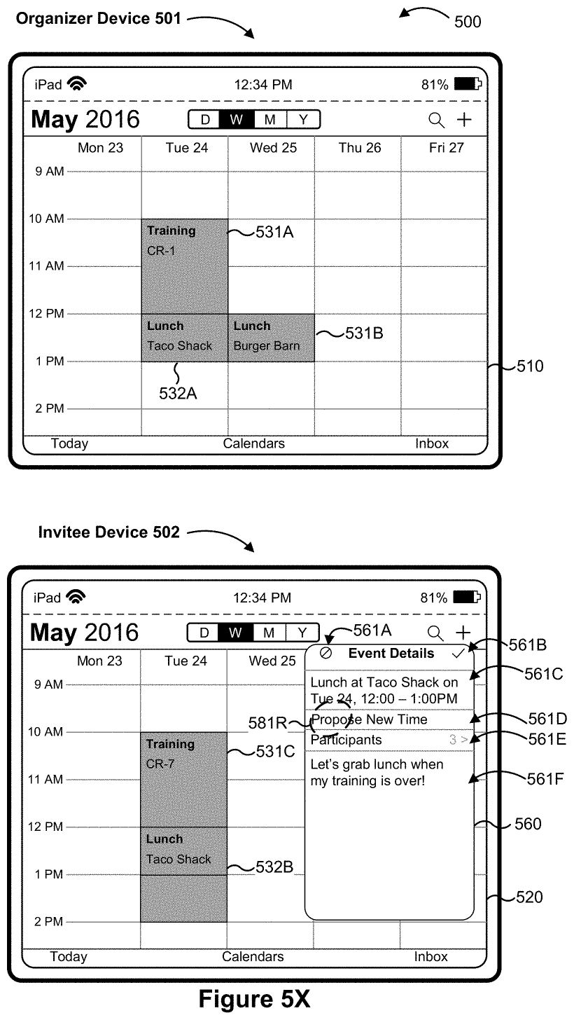

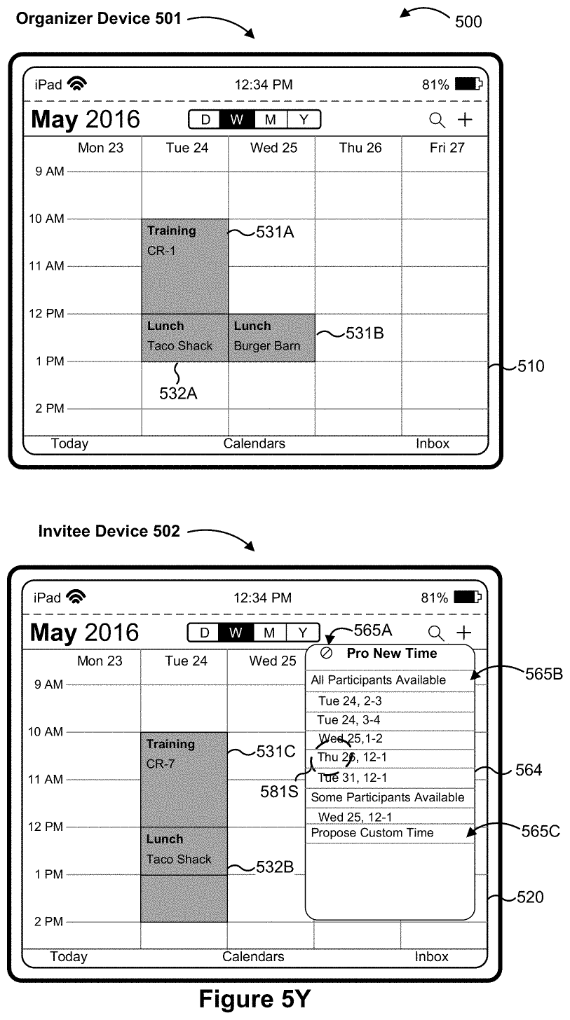

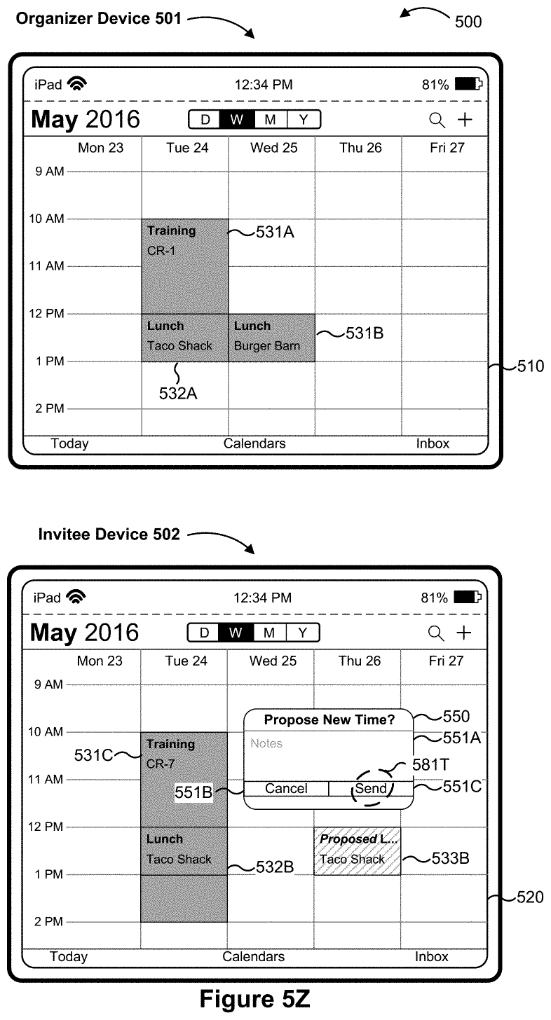

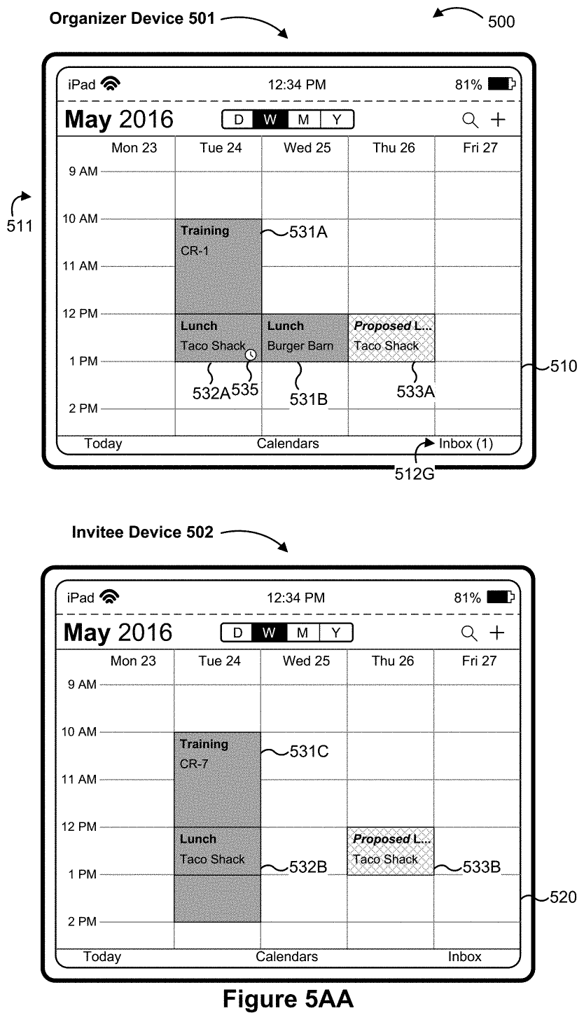

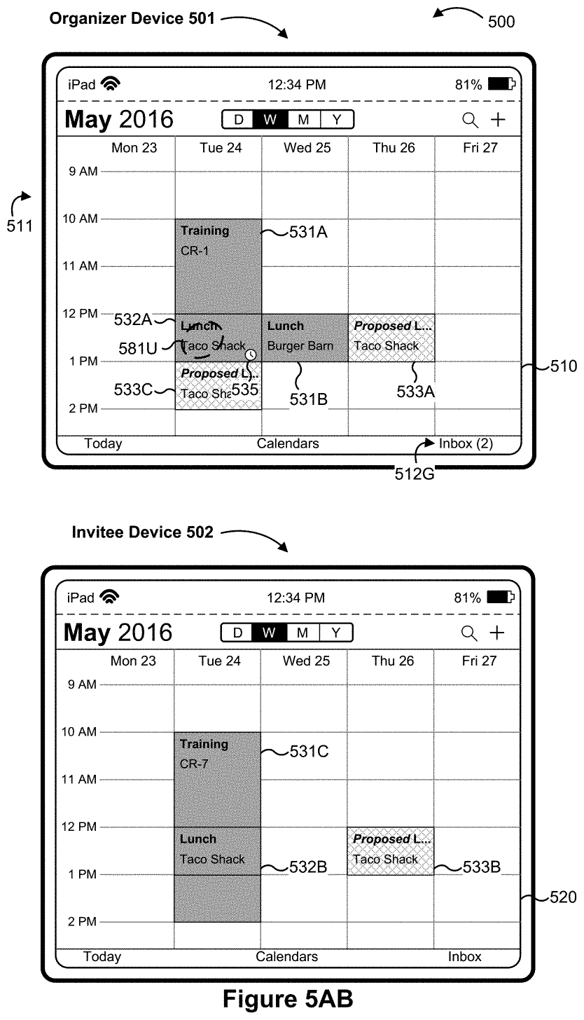

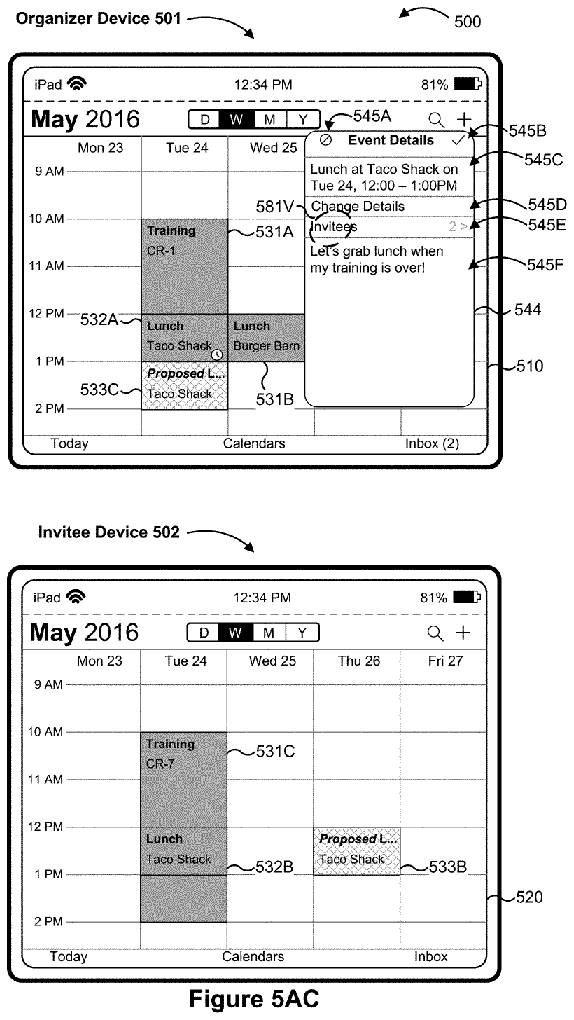

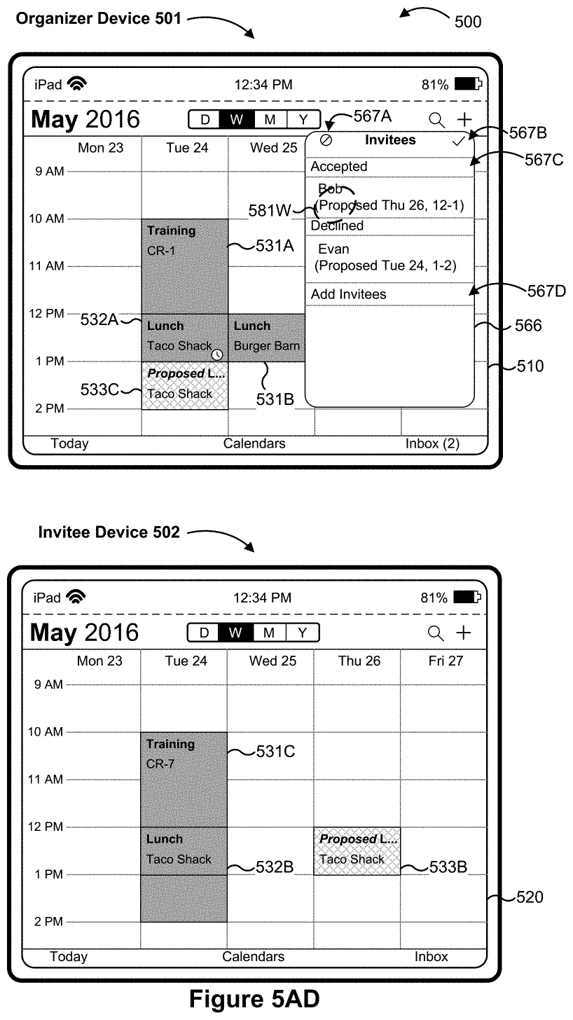

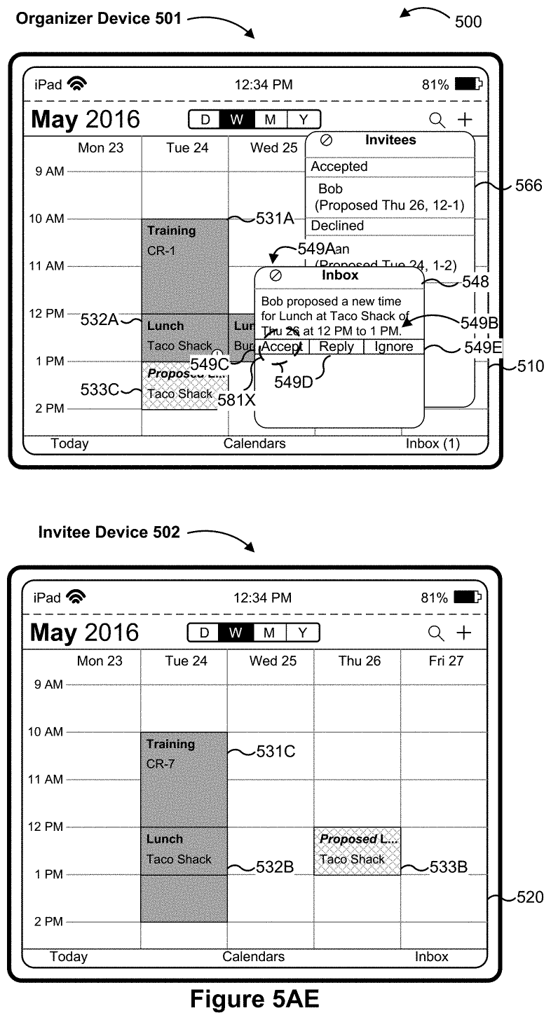

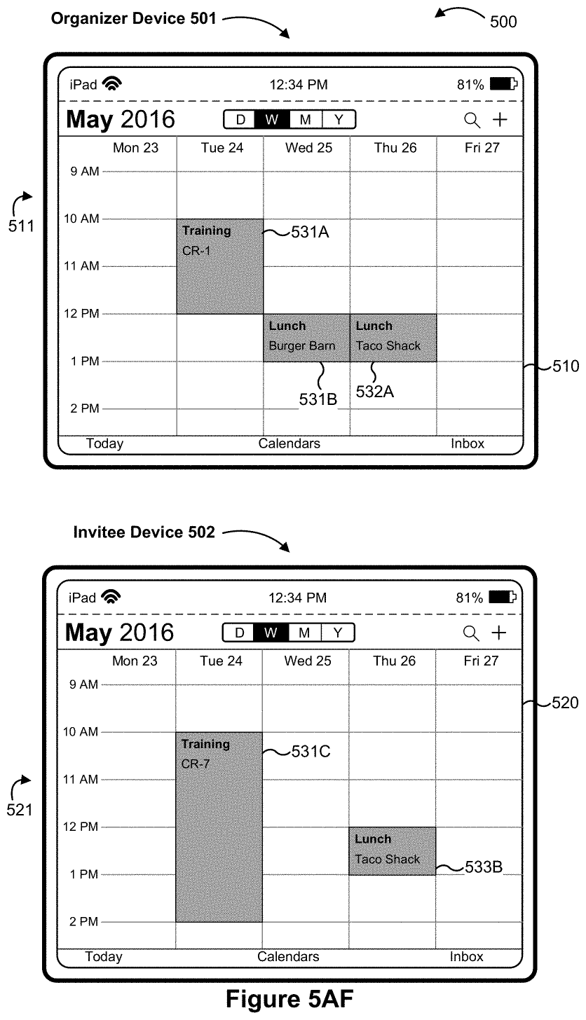

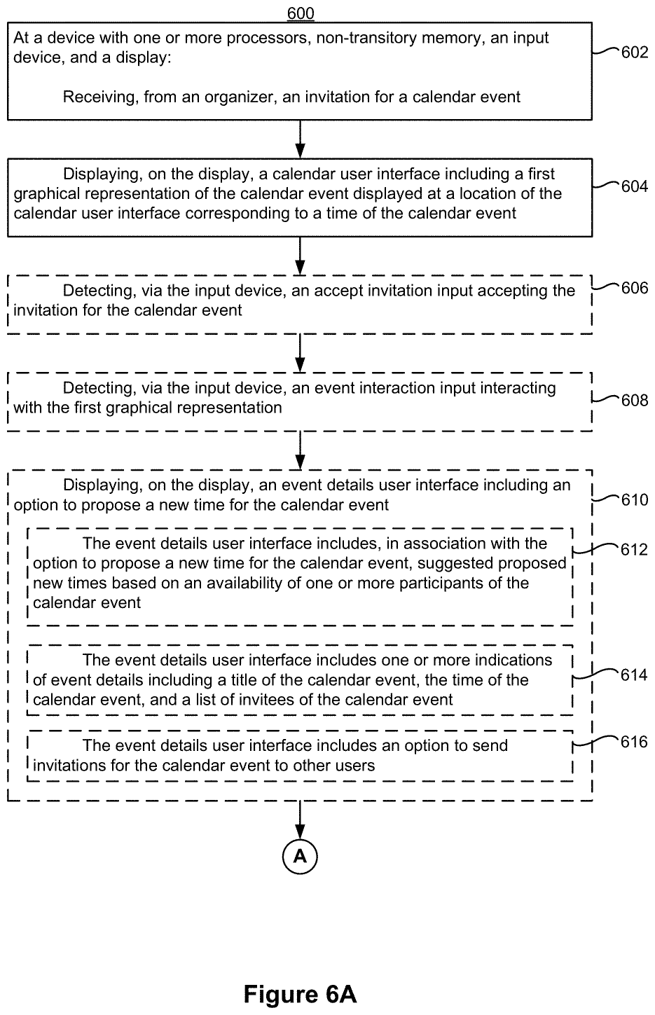

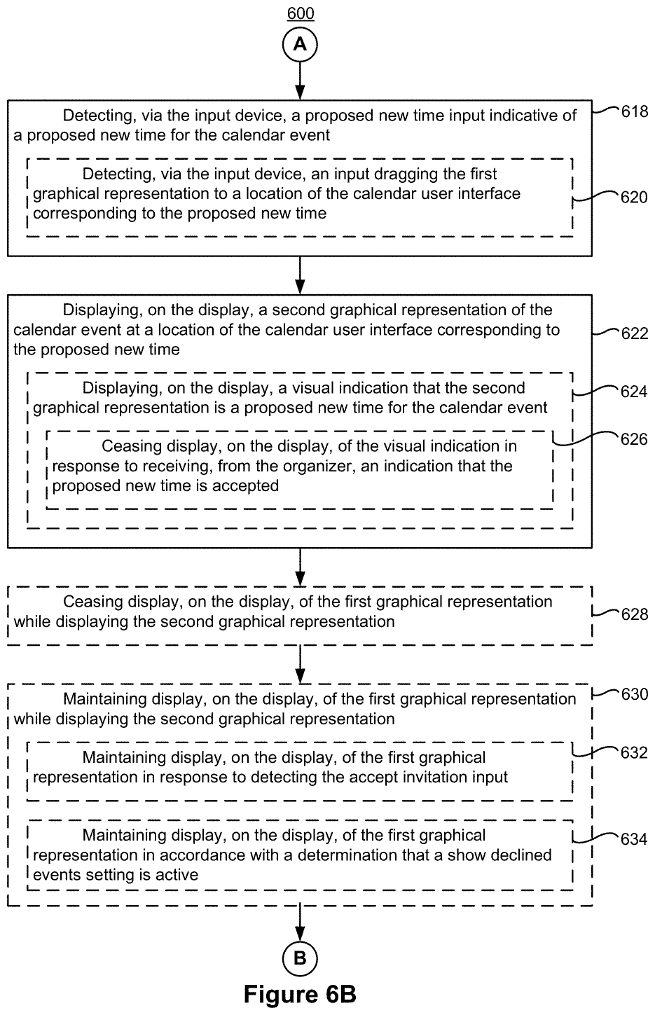

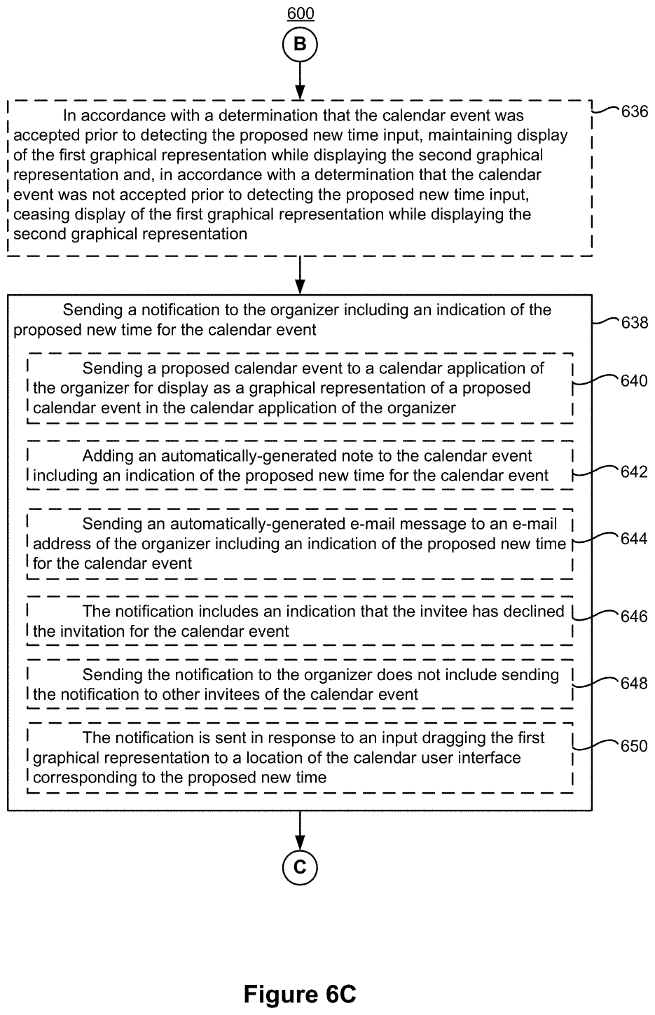

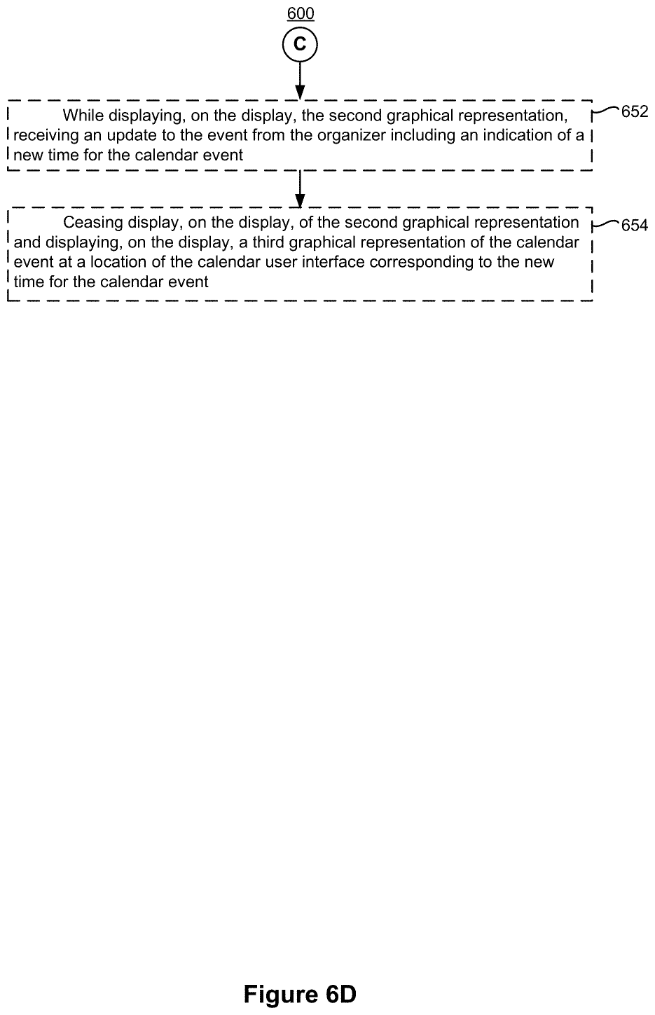

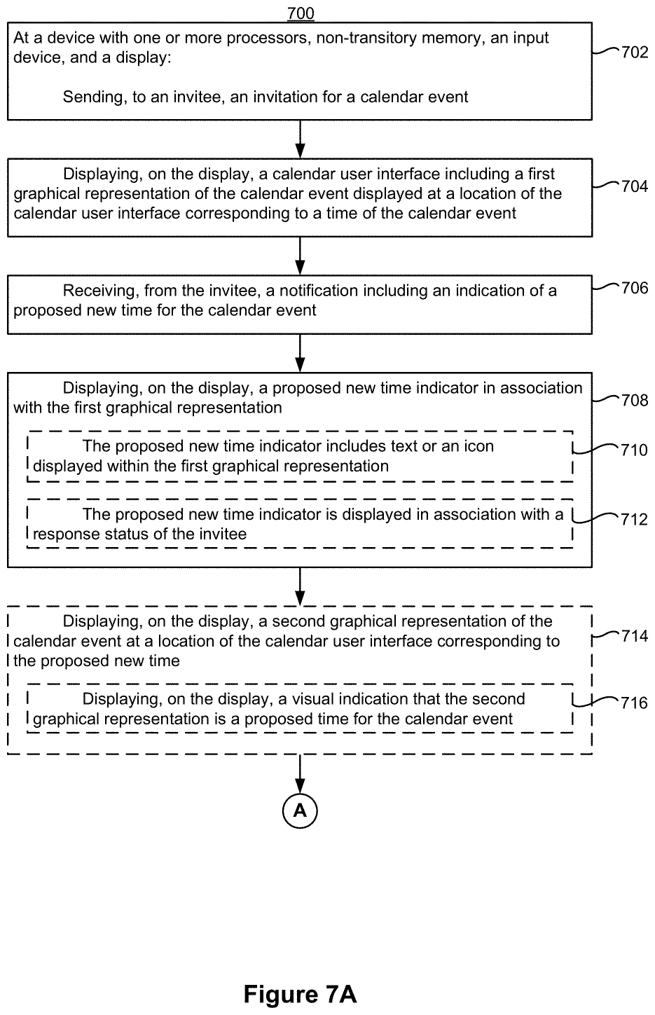

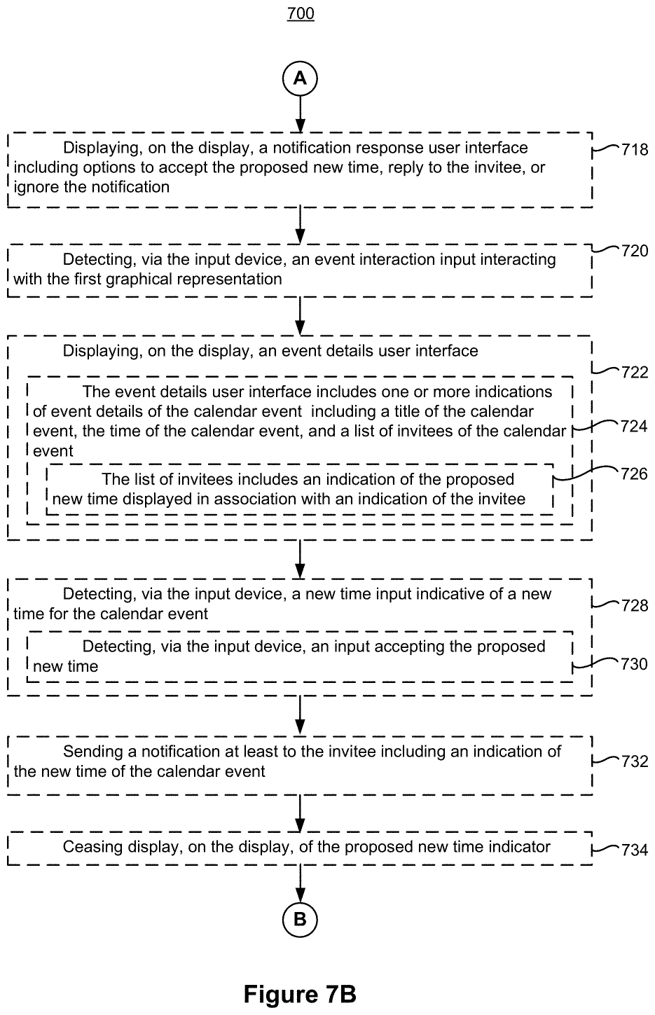

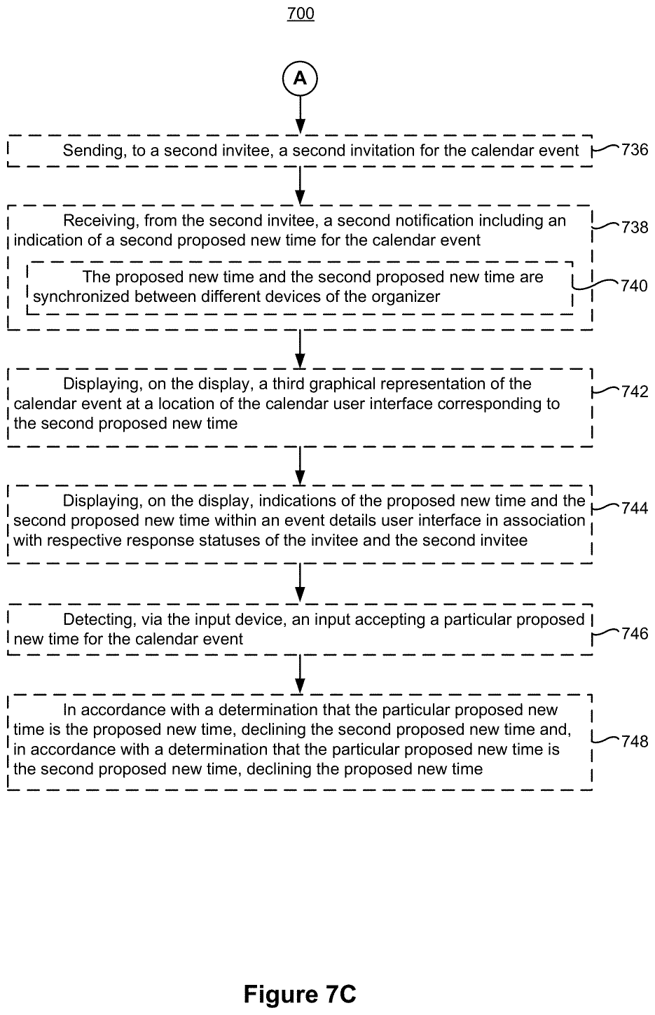

Below, FIGS. 1A-1B, 2, and 3 provide a description of example devices. FIGS. 4A-4B, 5A-5AF illustrate example user interfaces for changing the time of a calendar event. FIGS. 6A-6D illustrate a flow diagram of a method of changing the time of an invited calendar event. FIGS. 7A-7C illustrate a flow diagram of a method of changing the time of an organized calendar event. The user interfaces in FIGS. 5A-5AF are used to illustrate the processes in FIGS. 6A-6D and 7A-7C.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display system 112 of device 100). Device 100 optionally includes one or more tactile output generators 163 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

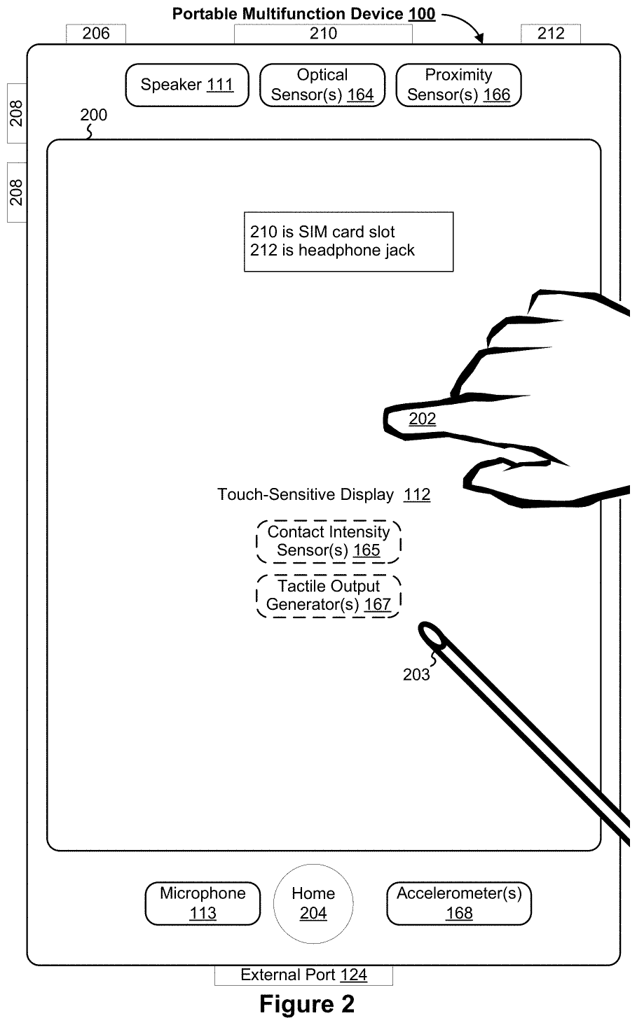

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user-interface objects.

Touch-sensitive display system 112 has a touch-sensitive surface, sensor or set of sensors that accepts input from the user based on haptic/tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In an example embodiment, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In an example embodiment, projected mutual capacitance sensing technology is used, such as that found in the iPhone®, iPod Touch®, and iPad® from Apple Inc. of Cupertino, Calif.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 163. FIG. 1A shows a tactile output generator coupled with haptic feedback controller 161 in I/O subsystem 106. Tactile output generator(s) 163 optionally include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 163 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 167, gyroscopes 168, and/or magnetometers 169 (e.g., as part of an inertial measurement unit (IMU)) for obtaining information concerning the position (e.g., attitude) of the device. FIG. 1A shows sensors 167, 168, and 169 coupled with peripherals interface 118. Alternately, sensors 167, 168, and 169 are, optionally, coupled with an input controller 160 in I/O subsystem 106. In some embodiments, information is displayed on the touch-screen display in a portrait view or a landscape view based on an analysis of data received from the one or more accelerometers. Device 100 optionally includes a GPS (or GLONASS or other global navigation system) receiver (not shown) for obtaining information concerning the location of device 100.

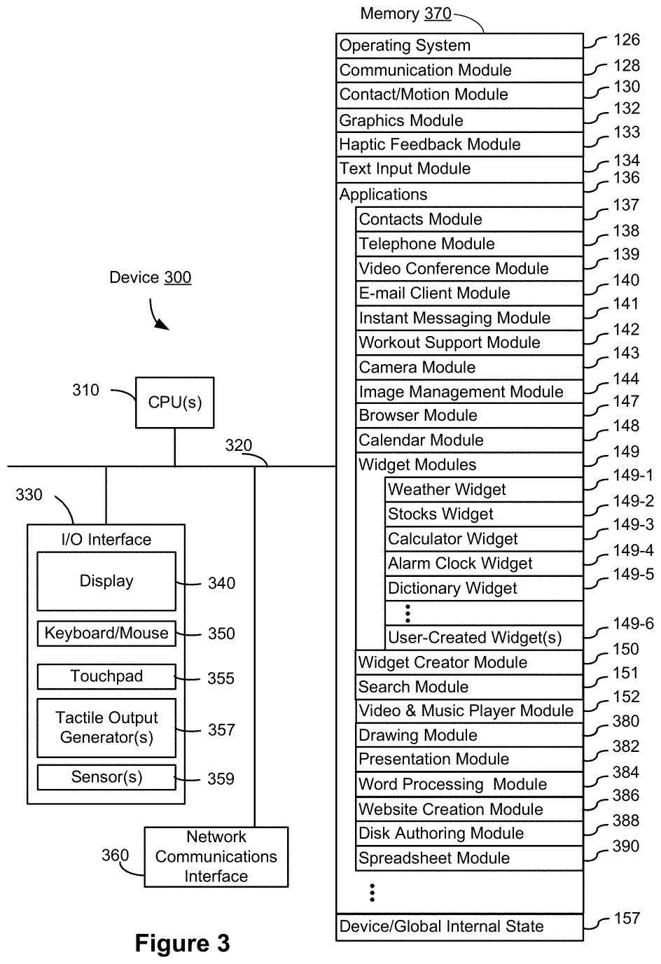

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, Calif. In some embodiments, the external port is a Lightning connector that is the same as, or similar to and/or compatible with the Lightning connector used in some iPhone®, iPod Touch®, and iPad® devices from Apple Inc. of Cupertino, Calif.

Contact/motion module 130 optionally detects contact with touch-sensitive display system 112 (in conjunction with display controller 156) and other touch-sensitive devices (e.g., a touchpad or physical click wheel). Contact/motion module 130 includes software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts and/or stylus contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 163 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display system controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display system controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display system controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 167, gyroscope(s) 168, magnetometer(s) 169, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensity of contacts on touch-sensitive display system 112 and/or one or more tactile output generators 163 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 163 described above with reference to FIG. 1A), sensors 359 (e.g., touch-sensitive, optical, contact intensity, proximity, acceleration, attitude, and/or magnetic sensors similar to sensors 112, 164, 165, 166, 167, 168, and 169 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, also referred to as iPod (trademark of Apple Inc.) module 152, labeled “iPod”; and
Icons for other applications, such as:
   Icon 424 for IM module 141, labeled “Text”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Map”;
   Icon 438 for weather widget 149-1, labeled “Weather”;
   Icon 440 for alarm clock widget 169-6, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, in some embodiments, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Device 300 also, optionally, includes one or more contact intensity sensors (e.g., one or more of sensors 359) for detecting intensity of contacts on touch-sensitive surface 451 and/or one or more tactile output generators 359 for generating tactile outputs for a user of device 300.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

### User Interfaces and Associated Processes

Attention is now directed towards embodiments of user interfaces (“UI”) and associated processes that may be implemented on an electronic device, such as portable multifunction device (PMD) 100 or device 300, with a display, a touch-sensitive surface, and one or more sensors to detect intensity of contacts with the touch-sensitive surface.

FIGS. 5A-5AF illustrate example user interfaces for changing the time of a calendar event in accordance with some embodiments. The user interfaces in these figures are used to illustrate the processes described below, including the processes in FIGS. 6A-6D and 7A-7C. Although some of the examples which follow will be given with reference to inputs on a touch-screen display (where the touch-sensitive surface and the display are combined), in some embodiments, the device detects inputs on a touch-sensitive surface 451 that is separate from the display 450, as shown in FIG. 4B. While the examples shown in FIGS. 5A-5AF here are described herein with respect to touch inputs detected on a touch-sensitive display, analogous user interfaces that use a different type of input are also considered to be within the scope of this concept. For example the touch inputs are, in some implementations, replaced with a cursor that is moved on the display by an input device such as a touch-sensitive surface (e.g., a trackpad), a mouse, a joystick, or other input device, and the touch inputs described below optionally correspond to the location of a focus selector (e.g., a cursor) that is displayed on the display to indicate which portion of the user interface inputs from the input device will affect.

FIG. 5A illustrates an environment 500 including an organizer device 501 and an invitee device 502. Each of the organizer device 501 and the invitee device 502 can be a portable multifunctional device such as the portable multifunctional device 100 of FIG. 1A or the device 300 of FIG. 3. Although illustrated in the same figure, it is to be appreciated that the organizer device 501 and invitee device 502 can be located in two different locations, in communication via a network, such as the internet.

The organizer device 501 includes a display that displays an organizer user interface 510. The organizer user interface 510 includes a device bar 519 at the top of the display including an identifier of the organizer device 501 (e.g., “iPad”), a wireless connection indicator, a current time, and a battery indicator indicating a charge level of the organizer device 501. The organizer user interface 510 includes an application region displaying a calendar user interface 511 of a calendar application.

Similarly, in FIG. 5A, the invitee device 502 includes a display that displays an invitee user interface 520. The invitee user interface 520 includes a device bar 529 at the top of the display including an identifier of the invitee device 502 (e.g., “iPad”), a wireless connection indicator, a current time, and a battery indicator indicating a charge level of the invitee device 502. The invitee user interface 520 includes an application region displaying a calendar user interface 521 of a calendar application.

The calendar user interface 511 of the organizer device 501 includes a first region 511A (at the top of the application region) with a temporal indication 512A (e.g., “May 2016”) indicating a time period associated with the view of the calendar application; a view toggle affordance 512B for changing a view of the calendar application between displaying information regarding a day, week, month, or year; a search affordance 512C for searching calendar events of the calendar application, and a new event affordance 512D for creating new calendar events.

The calendar user interface 511 of the organizer device 501 includes a second region 511B (in the middle of the application region) with a graphical representation of a time period, referred to as a canvas. In FIG. 5A, the canvas illustrates a time period including approximately five hours (e.g., from 9 AM to 2 PM) for five days (e.g., May 23, 2016 to May 27, 2016).

The calendar user interface 511 includes a third region 511C (at the bottom of the application region) with a today affordance 512E for moving a focus of the calendar application to today's date (e.g., for displaying in the second region 511B a time period including a current date), a calendars affordance 512F for adding or removing calendar event sets from display in the calendar user interface 511, and an inbox affordance 512G for viewing calendar application notifications. In various implementations, the calendar application notifications are distinct from notifications of other applications (e.g., e-mail notifications or e-mail messages of a mail application).

As illustrated in FIG. 5A, the calendar user interface 521 of the invitee device 502 includes substantially similar regions with substantially similar user interface objects.

In FIG. 5A, the calendar user interface 511 of the organizer device 501 includes, on the canvas, a first canvas element 531A associated with a first calendar event of the organizer. The first calendar event has an event title of “Training”, an event location of “CR-1”, and a time between 10 AM and 11 AM on Tuesday, May 24, 2016. The first canvas element 531A is a graphical representation of the first calendar event displayed at a location associated with the time of the first calendar event. The first canvas element 531A includes text indicating the event title of the first calendar event and the event location of the first calendar event. The calendar user interface 511 further includes a second canvas element 531B associated with a second calendar event of the organizer.

In FIG. 5A, the calendar user interface 521 of the invitee device 502 includes, on the canvas, a third canvas element 531C associated with a third calendar event of the invitee.

FIG. 5A illustrates a touch 581A detected on the organizer device 501 at a location of the new event affordance 512C.

FIG. 5B illustrates the environment 500 in response to detecting the touch 581A on the organizer device 501. FIG. 5B illustrates that, in response to detecting the touch 581A on the organizer device 501 at the location of the new event affordance 581A, the organizer user interface 510 includes a new event user interface 540 displayed within a new event window.

The new event user interface 540 includes a cancel affordance 541A for canceling creation of the new calendar event, an accept affordance 541B for creating the new calendar event, a title affordance 541C for setting or changing the event title of the new calendar event, a location affordance 541D for setting or changing the event location of the new calendar event, a start time affordance 541E for setting or changing the start time of the new calendar event, an end time affordance 541F for setting or changing the end time of the new calendar event, an invitees affordance 541G for adding invitees to the calendar event, and a notes affordance 541H for adding, deleting, or modifying notes of the new calendar event.

FIG. 5C illustrates the environment 500 in response to detecting user input interacting with the affordances of the new event user interface 540 to change various details of the new calendar event. In FIG. 5C, the title affordance 541C indicates that the event title of the new calendar event has been set to “Lunch”, the location affordance 541D indicates that the event location of the new calendar event has been set to “Taco Shack”, the start time affordance 541E and end time affordance 541F indicate that the time of the new calendar event has been set to Tuesday, May 24, 2016, from 12 PM to 1 PM, and the notes affordance 541G indicates that a note has been added to the new calendar event.

FIG. 5C illustrates a touch 581B detected at a location of the invitees affordance 541G of the organizer user interface 510.

FIG. 5D illustrates the environment 500 in response to detecting the touch 581B at the location of the invitees affordance 541G of the organizer user interface 510. FIG. 5D illustrates that, in response to detecting the touch 581B on the organizer device 501 at the location of the invitees affordance 541G, the organizer user interface 510 includes an invitees user interface 542 (as part of the new event user interface 540) displayed within the new event window.

The invitees user interface 542 includes a cancel affordance 543A for canceling the addition of invitees to the new calendar event, an accept affordance 543B for closing the invitees user interface 542, an invitees list affordance 543C indicating the invitees of the new calendar event and which can be used to add or delete invitees, and a set of potential invitee affordances 543D-543G associated with potential invitees (e.g., users identified by accessing a mail application of the organizer).

FIG. 5D illustrates a touch 581C detected at a location of a first one of the set of potential invitee affordances 543D associated with a first invitee (e.g., “Bob”) of the organizer user interface 510.

FIG. 5E illustrates the environment 500 in response to detecting the touch 581C at the location of the first one of the set of potential invitee affordances 543D of the organizer user interface 510. In FIG. 5E, the invitees list affordance 543C indicates that the first invitee has been added to the invitees list. Thus, the corresponding potential invitee affordance 543D is no longer displayed. FIG. 5E illustrates a touch 581D detected at a location, on the organizer user interface 510, of a second one of the set of potential invitee affordances 543G associated with a second invitee (e.g., “Evan”).

FIG. 5F illustrates the environment 500 in response to detecting the touch 581D at the location of the second one of the set of potential invitee affordances 543G of the organizer user interface. In FIG. 5E, the invitees list affordance 543C indicates that the second invitee has been added to the invitees list. Thus, the corresponding potential invitee affordance 543G is no longer displayed. FIG. 5F illustrates a touch 581E detected at a location of the accept affordance 543B.

FIG. 5G illustrates the environment 500 in response to detecting the touch 581D at the location of the accept affordance 543B of the organizer user interface 510. In FIG. 5G, the invitees user interface 542 portion of the new event user interface 540 is no longer displayed on the organizer user interface 510. The invitees affordance 541G of the new event user interface 540 indicates that there are two invitees (e.g., the first invitee, “Bob”, and the second invitee, “Evan”).

FIG. 5G illustrates a touch 581F detected at a location of the invitees affordance 541G of the new event user interface 540 of the organizer user interface 510.

FIG. 5H illustrates the environment 500 in response to detecting the touch 581F at the location of the invitees affordance 541G on the organizer user interface 510. In FIG. 5H, the invitees user interface 542 is once again displayed. The invitees user interface 542 displays a list of the invitees, each in association of a response indicator. In FIG. 5H, the invitees user interface 542 indicates that neither the first invitee nor the second invitee has responded to an invitation to the calendar event. The invitees user interface 542 includes an add invitees affordance 543H for adding additional invitees to the calendar event. The invitees user interface 542 includes a back affordance 543I for closing the invitees user interface 542.

FIG. 5H illustrates a touch 581G detected at a location of the back affordance 543I of the invitees user interface 542 of the organizer user interface 510.

FIG. 5I illustrates the environment 500 in response to detecting the touch 581G at the location of the back affordance 543I of the organizer user interface 510. In FIG. 5I, the invitees user interface 542 is no longer displayed on the organizer user interface 510. FIG. 5I illustrates a touch 581H detected at a location of the accept affordance 541B of the new event user interface 540 of the organizer user interface 510.

FIG. 5J illustrate the environment 500 in response to detecting the touch 581G at the location of the accept affordance 541B of the organizer user interface 510. In FIG. 5J, the organizer user interface 510 includes a new canvas element 532A associated with the new calendar event generated by the organizer. The invitee user interface 520 also includes a new canvas element 532B associated with the new calendar event. The new canvas element 532B on the invitee user interface 520 is displayed with an indication that invitee has not accepted an invitation to the new calendar event, e.g., a different color, brightness, opacity, or other visual characteristic. For example, in FIG. 5J, the new canvas element 532B is displayed in with parallel hatching rather than a solid gray color like the third canvas element 531C.

FIG. 5J illustrates a touch 581H detected at a location of the inbox affordance 522G of the invitee user interface 520.

FIG. 5K illustrates the environment 500 in response to detecting the touch 581H at the location of the inbox affordance 522G of the invitee user interface 520. In response to detecting the touch 581H at the location of the inbox affordance 522G, the invitee user interface 520 includes an inbox user interface 546 displayed in an inbox window. The inbox user interface 546 includes a close affordance 547A for closing the inbox window (and ceasing display of the inbox user interface 546), descriptive text 547B including indications of event details of the new calendar event, an accept affordance 547C for sending an accept response to the organizer for the new calendar event, a maybe affordance 547D for sending a maybe response to the organizer for the new calendar event, a decline affordance 547E for sending a decline response to the organizer for the new calendar event, and a propose new time affordance 547F for opening a propose new time user interface (described below) that can be used to propose a new time to the organizer for the new calendar event.

FIG. 5K illustrates a touch 581I detected at a location of the close affordance 547A of the inbox user interface 546 of the invitee user interface 510.

FIG. 5L illustrates the environment 500 in response to detecting the touch 581I at the location of the close affordance 547A of the invitee user interface 510. In FIG. 5L, the inbox user interface 546 is no longer displayed. FIG. 5L illustrates a drag 581J starting at a location of the new canvas element 532B of the invitee user interface 520 and moving towards a location of the calendar user interface 521 associated with a proposed new time.

FIG. 5M illustrates the environment 500 in response to detecting a first portion of the drag 581J (e.g., movement of the contact a first distance) starting at the location of the new canvas element 532B of the invitee user interface 520. In FIG. 5M, the new canvas element 532B of the invitee user interface 520 is no longer displayed and a proposed canvas element 533B is displayed on the calendar user interface 521 at a location associated with a proposed new time (e.g., Thursday, May 26, 2016, from 12 PM to 1 PM). The proposed canvas element 533B of the invitee user interface 520 is displayed with a visual indication that the proposed canvas element 533B is displayed at a location corresponding to a proposed new time for the new calendar event (as opposed to the time of the new calendar event). For example, in FIG. 5N, the new canvas element 532B is displayed with parallel hatching and, in FIG. 5M, the proposed canvas element 533B is displayed with cross-hatching. Further, the proposed canvas element 533B is displayed with the italic text “Proposed” in front of the event title. In various implementations, the visual indication can be an added icon or text or a change in color, brightness, opacity, or other visual characteristic of the proposed canvas element 533B.

FIG. 5N illustrates that environment 500 in response to detecting a second portion of the drag 581K (e.g., liftoff of the contact) starting at the location of the new canvas element 532B of the invitee user interface 520 in accordance with some embodiments in which the organizer device 501 includes a calendar application that can receive calendar application notifications to a calendar inbox. In FIG. 5N, a confirmation user interface 550 is displayed on the invitee user interface 510 within a confirmation window. The confirmation user interface 550 includes a notes affordance 551A for adding a note to a notification proposing a new time for the new calendar event, a cancel affordance 551B for canceling proposal of the new time (and returning the environment 500 to the state of FIG. 5L before the drag 581J was detected), and a send affordance 551C for sending a calendar application notification to the organizer including an indication of the proposed new time for the new calendar event.

In some implementations, a notification is sent to the organizer in response to the drag 581J without displaying a confirmation user interface 550. Thus, the notification is sent automatically without further user input so that sending a proposed new time is as intuitive as dragging a canvas element to a new location in the user's calendar.

FIG. 5N illustrates that a touch 581K is detected at a location of the send affordance 551C of the confirmation window 550 of the invitee user interface 510.

FIG. 5O illustrates that environment 500 in response to detecting a second portion of the drag 581K (e.g., liftoff of the contact) starting at the location of the new canvas element 532B of the invitee user interface 520 in accordance with some embodiments in which the organizer device 501 does not include a calendar application that can receive calendar application notifications to a calendar inbox, but in which invitees can add notes (or comments) to a calendar event. In FIG. 5O, a confirmation user interface 552 is displayed on the invitee user interface 510 within a confirmation window. The confirmation user interface 552 includes a notes affordance 552A that is pre-populated with text indicating that the invitee is proposing the new time for the new calendar event. By touching the notes affordance 552A, the invitee can customize the text, if desired. The confirmation user interface 552 further includes a cancel affordance 553B for canceling proposal of the new time (and returning the environment 500 to the state of FIG. 5L before the drag 581J was detected), and an add affordance 553C for adding the note to the new calendar event.

In some implementations, the note is added to the new calendar event in response to the drag 581J without displaying a confirmation user interface 552. Thus, the note is added to the calendar event automatically without further user input so that sending a proposed new time is as intuitive as dragging a canvas element to a new location in the user's calendar. Further, in some embodiments, when a time for the proposed event is changed again by the invitee, the note from the invitee is overwritten so that the organizer only sees the most recently proposed time from the invitee.

In various implementations, an automatically-generated note is added to the calendar event when it is determined (e.g., by a calendar server or the invitee's device) that the organizer's calendar application is not configured for (e.g., has a software version that does not support) displaying a proposed calendar event based on a proposed new time from an invitee.

FIG. 5P illustrates that environment 500 in response to detecting a second portion of the drag 581K (e.g., liftoff of the contact) starting at the location of the new canvas element 532B of the invitee user interface 520 in accordance with some embodiments in which the organizer device 501 does not include a calendar application that can receive calendar application notifications to a calendar inbox and in which invitees cannot add notes (or comments) to a calendar event. In FIG. 5P, a confirmation user interface 554 is displayed on the invitee user interface 510 within a confirmation window. The confirmation user interface 554 includes an e-mail text affordance 555B that is pre-populated with text indicating that the invitee is proposing the new time for the new calendar event. By touching the e-mail text affordance 555A, the invitee can customize the text of an e-mail message to the organizer, if desired. The confirmation user interface 554 further includes a cancel affordance 555B for canceling proposal of the new time (and returning the environment 500 to the state of FIG. 5L before the drag 581J was detected), and a send affordance 555C for sending an e-mail (including the text of the e-mail text affordance 555B) to the organizer.

In some implementations, an e-mail is sent to the organizer in response to the drag 581J without displaying a confirmation user interface 554. Thus, the e-mail is sent to the organizer automatically without further user input so that sending a proposed new time is as intuitive as dragging a canvas element to a new location in the user's calendar.

In various implementations, the e-mail is sent when it is determined (e.g., by a calendar server or the invitee's device) that the organizer's calendar application is not configured for (e.g., has a software version that does not support) displaying a proposed calendar event based on a proposed new time from an invitee and is not configured for (e.g., has a software version that does not support) adding an automatically-generated note to the calendar event.

FIG. 5Q illustrates the environment 500 in response to detecting the touch 581K (in FIG. 5N) at the location of the send affordance 551C of the invitee user interface 520. As mentioned above, in some implementations, a confirmation user interface 550 is not displayed. Thus, in some embodiments, FIG. 5Q illustrates the environment 500 in response to detecting the second portion of the drag 581J (e.g., liftoff of the contact) starting at the location of the new canvas element 532B of the invitee user interface 520.

In FIG. 5Q, in response to receiving a notification from the invitee including an indication of a proposed new time for the new calendar event, the organizer user interface 510 includes a proposed canvas element 533A at a location of the calendar user interface 511 corresponding to the proposed new time. Further, the organizer user interface 510 includes a proposed new time icon 535 displayed in association with the new canvas element 532A. In various implementations, the proposed new time icon 535 displayed at the bottom of the new canvas element 532A. In various implementations, the proposed new time icon 535 can be replaced (or supplemented) with text displayed at the bottom of the new canvas element 532A.

In FIG. 5Q, the inbox affordance 512G indicates that the organizer has received a calendar application notification. FIG. 5Q illustrates a touch 581L detected at a location of the inbox affordance 512G of the organizer user interface 510.

FIG. 5R illustrates the environment 500 in response to detecting the touch 581L at the location of the inbox affordance 512G of the organizer user interface 510. In FIG. 5R, the organizer user interface 510 includes an inbox user interface 548 displayed in an inbox window. The inbox user interface 548 includes a close affordance 549A for closing the inbox window (and ceasing display of the inbox user interface 548), descriptive text 549B including details regarding the proposed new time for the new calendar event, an accept affordance 549C for sending an accept response to the invitee for proposed new time for the new calendar event, a reply affordance 549D for sending a reply to the invitee in response to the proposed new time for the new calendar event, and an ignore affordance 549E for ignoring the notification.

FIG. 5R illustrates a touch 581M detected at a location of the accept affordance 549C of the inbox user interface 548 of the organizer user interface 510.

FIG. 5S illustrates the environment 500 in response to detecting the touch 581M at the location of the accept affordance 549C of the organizer user interface 510. In FIG. 5S, on the organizer user interface 510, the proposed canvas element 533A is replaced with the new canvas element 532A which is moved to location of the calendar user interface 511 associated with the proposed new time (which becomes the time of the new calendar event). Further, the new canvas element 532A is no longer displayed with the proposed new time indicator 535. On the invitee user interface 520, the new canvas element 532B is no longer displayed with a visual indication that the new canvas element 532B is located at a proposed new time for the calendar event. For example, in FIG. 5S, the new canvas element 532B is displayed with a solid gray color indicating that invitee has accepted the new calendar event at the proposed new time (which has become the time of the new calendar event). Further, the new canvas element 532B is no longer displayed with the italic text “Proposed” in front of the event title.

FIG. 5T, like FIG. 5K, illustrates the environment 500 in response to detecting the touch 581H (in FIG. 5J) at the location of the inbox affordance 522G of the invitee user interface 520. However, unlike FIG. 5K, FIG. 5T illustrates a touch 581N detected at a location of the accept affordance 547C of the inbox user interface 546 of the invitee user interface 520.

FIG. 5U illustrates the environment 500 in response to detecting the touch 581N at the location of accept affordance 547C of the inbox user interface 546. In FIG. 5U, the new canvas element 532B is displayed in a solid gray color indicating that the invitee has accepted the invitation to the new calendar event. FIG. 5U illustrates a touch 581O detected at a location of the new canvas element 532B of the invitee user interface 520.

FIG. 5V illustrates the environment 500 in response to detecting the touch 581N at the location of the new canvas element 532B of the invitee user interface. In FIG. 5V, the invitee user interface 520 includes an event details user interface 560 displayed in an event details window. The event details user interface 560 includes an accept affordance 561A for accepting changes to the new calendar event (e.g., the addition, deletion, or modification of notes via the notes affordance 561F), a cancel affordance 561B for canceling changes to the new calendar event, descriptive text 561C including indications of event details of the new calendar event, a propose new time affordance 561D for proposing a new time for the new calendar event, a participants affordance 561E for viewing the participants of and adding invitees to the new calendar event, and a notes affordance 561F for adding, deleting, or modifying notes of the calendar event. FIG. 5V illustrates a touch 581P detected at a location of the participants affordance 561E of the event details user interface 560 of the invitee user interface 520.

FIG. 5W illustrates the environment 500 in response to detecting the touch 581P at the location of the participants affordance 561E of the invitee user interface 520. In FIG. 5W, the invitee user interface 520 includes a participants user interface 562 (part of the event details user interface 560) within the event details window. The participants user interface 562 includes a cancel affordance 563A for canceling changes to the participants of the new calendar event, an accept affordance 563B for accepting changes to the participants of the new calendar event (and sending invitations to any added invitees), descriptive text 563C indicating the organizer of the new calendar event, an invitee listing 563D listing the invitees of the new calendar event in association with a response status of each of the invitees, and an add invitee affordance 563E for adding invitees to the new calendar event. Thus, the add invitee affordance 563E (displayed as part of the invitee user interface 520) allows an invitee to add other invitees to the new calendar event without the participation of the organizer.

FIG. 5W illustrates a touch 581Q at a location of the cancel affordance 563A of the participants user interface 562 of the invitee user interface 520.

FIG. 5X illustrates the environment 500 in response to detecting the touch 581Q at the location of the cancel affordance 563A of the invitee user interface 520. In FIG. 5X, the participants user interface 562 is no longer displayed. FIG. 5X illustrates a touch 581R detected at a location of the propose new time affordance 561D of the event details user interface 560 of the invitee user interface 520.

FIG. 5Y illustrates the environment 500 in response to detecting the touch 581R at the location of the propose new time affordance 561D of the invitee user interface 520. In FIG. 5Y, the invitee user interface 520 includes a propose new time user interface 564 (part of the event details user interface 560) within the event details window. The propose new time user interface 564 includes a cancel affordance 565A for canceling proposal of a new time for the new calendar event. The propose new time user interface 564 includes a suggested proposed new time listing 565B including a number of suggested proposed new time affordances for selecting respective suggested proposed new times. The suggested proposed new times are based on the availability of the participants of the calendar event (e.g., whether the participants do not have calendar events having event times at the suggested proposed new times). Thus, the suggested proposed new time listing 565B displays one or more available times of one or more participants of the new calendar event. The suggested proposed new times can include a set of times in which all participants are available (e.g., the organizer and other invitees are available) and/or a set of times in which some of the participants are available.

FIG. 5Y illustrates a touch 581S detected, on the invitee user interface 520, at a location of one of the suggested proposed new time affordances corresponding to a proposed new time of Thursday, May 26, 2016, from 12 PM to 1 PM.

FIG. 5Z illustrates the environment 500 in response to detecting the touch 581S at the location of the suggested proposed new time affordance of the invitee user interface 520. In FIG. 5Z, the confirmation user interface 550 is displayed. In various implementations, a notification is sent to the organizer of the new calendar event in response to detecting the touch 581S at the location of the suggested proposed new time affordance without displaying the confirmation user interface 550. FIG. 5Z illustrates a touch 581T detected at a location of the send affordance 551C of the confirmation user interface 550 of the invitee user interface 520.

FIG. 5AA illustrates the environment 500 in response to detecting the touch 581T at the location of the send affordance 551C of the invitee user interface 520. In FIG. 5AA, in response to receiving a notification from the invitee including an indication of a proposed new time for the calendar event, the organizer user interface 510 includes a proposed canvas element 533A at a location of the calendar user interface 511 corresponding to the proposed new time. Further, the organizer user interface 510 includes a proposed new time icon 535 displayed in association with the new canvas element 532A. In FIG. 5AA, the inbox affordance 512G indicates that the organizer has received a calendar application notification.

FIG. 5AB illustrates the environment 500 in response to the organizer receiving a notification from the second invitee proposing a second proposed new time for the new calendar event. In addition to the proposed canvas element 533A, the organizer user interface 510 includes a second proposed canvas element 533C at a location of the calendar user interface 511 corresponding to the second proposed new time proposed by the second invitee. Further, the inbox affordance 512G indicates that the organizer has received two calendar application notifications, a first notification from the first invitee indicating the proposed new time and a second notification from the second invitee indicating the second proposed new time.

In FIG. 5AB, the invitee user interface 520 does not include a second proposed canvas element as the first invitee does not receive a notification from the second invitee indicating the second proposed new time. However, in some implementations, in addition to the organizer, other invitees may receive a notification including an indication of a proposed new time for a calendar event and, optionally, display a corresponding proposed canvas element at a location of the calendar user interface corresponding to the proposed new time.

FIG. 5AB illustrates a touch 581U detected at a location of the new canvas element 532A of the organizer user interface 510.

FIG. 5AC illustrates the environment 500 in response to detecting the touch 581U at the location of the new canvas element 532A of the organizer user interface 510. In FIG. 5AC, the organizer user interface 510 includes an event details user interface 544 displayed in an event details window. The event details user interface 544 includes a cancel affordance 545A for cancelling changes to the new calendar event, an accept affordance 545B for accepting changes to the new calendar event, descriptive text 545C including indications of event details of the new calendar event, a change details affordance 545D for changing details of the new calendar event (e.g., the event title, the event location, or the time of the new calendar event), an invitees affordance 545E for viewing invitees of and adding invitees to the new calendar event, and a notes affordance 545F for deleting, adding, or modifying notes of the new calendar event.

FIG. 5AC illustrates a touch 581V detected at a location of the invitees affordance 565E of the event details user interface 564 of the organizer user interface 520.

FIG. 5AD illustrates the environment 500 in response to detecting the touch at the location of the invitees affordance 565E of the organizer user interface 510. In FIG. 5AD, the organizer user interface 520 includes an invitees user interface 566 (part of the event details user interface 544) within the event details window. The invitees user interface 566 includes a cancel affordance 567A for canceling changes to the invitees of the new calendar event, an accept affordance 567B for accepting changes to the invitees of the new calendar event (and sending invitations to any added invitees), an invitee listing 567C listing the invitees of the new calendar event in association with a response status of each of the invitees, and an add invitee affordance 567D for adding invitees to the new calendar event. The invitee listing 567C includes proposed new time indicators displayed in association with a response status of the invitees. In particular, the first invitee (“Bob”) is displayed in association with an accepted response status and a proposed new time of Thursday, May 26, 2016, from 12 PM to 1 PM. The second invitee (“Evan”) is displayed in association with a declined response status and a proposed new time of Tuesday, May 24, 2016, from 1 PM to 2 PM.

FIG. 5AD illustrates a touch 581W at a location of the proposed new time indicator of the first invitee of the invitee listing 567C of the invitees user interface 566 of the organizer user interface 510.

FIG. 5AE illustrates the environment 500 in response to detecting the touch 581W at the location of the proposed new time indicator of the first invitee of the organizer user interface 510. In FIG. 5AE, the organizer user interface 510 includes the inbox user interface 548 displayed in an inbox window. FIG. 5AE illustrates a touch 581X detected at a location of the accept affordance 549D of the inbox user interface 548 of the organizer user interface 510.

FIG. 5AF illustrates the environment 500 in response to detecting the touch 581X at the location of the accept affordance 549D of the organizer user interface 510. In FIG. 5AF, on the organizer user interface 510, the proposed canvas element 533A is replaced with the new canvas element 532A which is moved to location of the calendar user interface 511 associated with the proposed new time (which becomes the time of the calendar event). Further, the new canvas element 532A is no longer displayed with the proposed new time indicator 535. Further still, the second proposed canvas element 533C is removed in response to changing the time of the new calendar event. On the invitee user interface 520, the proposed canvas element 533B is no longer displayed with a visual indication that the proposed canvas element 533B is displayed at a location of the calendar user interface 521 corresponding to a proposed new time for the new calendar event.

FIGS. 6A-6D illustrate a flow diagram of a method 600 of method of proposing a new time for an invited calendar event in accordance with some embodiments. The method 600 is performed at an electronic device (e.g., the portable multifunction device 100 in FIG. 1A, the device 300 in FIG. 3, or the invitee device 502 of FIG. 5) with a display and a touch-sensitive surface. In some embodiments, the display is a touch-screen display and the touch-sensitive surface is on or integrated with the display. In some embodiments, the display is separate from the touch-sensitive surface. Some operations in method 600 are, optionally, combined and/or the order of some operations is, optionally, changed.

As described below, the method 600 provides an intuitive way to propose a new time for an invited calendar event. The method reduces the cognitive burden on a user when proposing a new time for an invited calendar event, thereby creating a more efficient human-machine interface. For battery-operated electronic devices, enabling a user to propose a new time for an invited calendar event faster and more efficiently conserves power and increases the time between battery charges.

The device receives (602), from an organizer, an invitation for a calendar event. For example, in FIG. 5J, the inbox affordance 522G of the invitee user interface 520 indicates that the first invitee has received an invitation to the new calendar event.

The device displays (604), on the display, a calendar user interface including a first graphical representation of the calendar event displayed at a location of the calendar user interface corresponding to a time of the calendar event. For example, in FIG. 5J, the invitee user interface 520 includes the new canvas element 532B displayed on the calendar user interface 521 at a location corresponding to the time of the new calendar event (e.g., Tuesday, May 24, 2016, from 12 PM to 1 PM).

In some embodiments, the device detects (606), via the input device, an accept invitation input accepting the invitation for the calendar event. For example, in FIG. 5T, a touch 581N is detected at the location of the accept affordance 547C of the inbox user interface 546 of the invitee user interface 510.

In some embodiments, the device detects (608), via the input device, an event interaction input interacting with the first graphical representation. For example, in FIG. 5U, a touch 581O is detected at the location of the new canvas element 532B.

In some embodiments, in response to detecting the event interaction input, the device displays (610), on the display, an event details user interface including an option to propose a new time for the calendar event. For example, in FIG. 5V, in response to detecting the touch 581O at the location of the new canvas element 532B in FIG. 5U, the invitee user interface 520 includes an event details user interface 560 including a propose new time affordance 561D for proposing a new time for the new calendar event.

In some embodiments, the event details user interface includes (612), in association with the option to propose a new time for the calendar event, suggested proposed new times based on an availability of one or more participants of the calendar event. Thus, a user need not send inquiries to other participants regarding their availability (or attempt to access information regarding their availability), reducing interaction with the device. Reducing interaction with the device conserves power and increases the time between battery charges and reduces wear-and-tear of the device. For example, in FIG. 5Y, the invitee user interface 520 includes a propose new time user interface 564 (part of the event details user interface 560) that includes a suggested proposed new time listing 565B including a number of suggested proposed new time affordances based on the availability of the participants of the calendar event (e.g., whether the participants do not have calendar events having event times at the suggested proposed new times).

In some embodiments, the event details user interface includes (614) one or more indications of event details of the calendar event including a title of the calendar event, the time of the calendar event, and a list of invitees of the calendar event. For example, in FIG. 5V, the event details user interface 560 includes descriptive text 561C including indications of the event tile of the new calendar event (e.g., “Lunch) and the time of the new calendar event (e.g., Tuesday, May 24, 2016, from 12 PM to 1 PM). In FIG. 5W, the participants user interface 562 (part of the event details user interface 560) includes an invitee listing 563D listing the invitees of the new calendar event (and descriptive text 563C indicating the organizer of the new calendar event).

In some embodiments, the event details user interface includes (616) an option to send invitations for the calendar event to other users. For example, in FIG. 5W, the participants user interface 562 (part of the event details user interface 560) includes an add invitees affordance 563E for sending invitations for the new calendar event to other users.

The device detects (618), via the input device, a proposed new time input indicative of a proposed new time for the calendar event. For example, in FIG. 5Y, the invitee device 502 detects a touch 581S at a location of one of the suggested proposed new time affordances 565B of the propose new time user interface 564. In some embodiments, the device detects (620), via the input device, an input dragging the first graphical representation to a location of the calendar user interface corresponding to the proposed new time. For example, in FIGS. 5N-5M, the invitee device 502 detects a drag 581J starting at a location of the new canvas element 532B and dragging it to a location of the calendar user interface corresponding to a proposed new time of Thursday, May 26, 2016, from 12 PM to 1 PM.

In response to detecting the proposed new time input, the device displays (622), on the display, a second graphical representation of the calendar event at a location of the calendar user interface corresponding to the proposed new time. Thus, the likelihood of scheduling another conflicting calendar event at the proposed new time is reduced, reducing interaction with the device to resolve the conflict. Reducing interaction with the device conserves power and increases the time between battery charges and reduces wear-and-tear of the device. For example, in FIG. 5Q, the invitee user interface 520 includes the proposed canvas element 533B at a location of the calendar user interface corresponding to the proposed new time of Thursday, May 26, 2016, from 12 PM to 1 PM. As another example, in FIG. 5AA, the invitee user interface 520 includes the proposed canvas element 533B at a location of the calendar user interface corresponding to the proposed new time of Thursday, May 26, 2016, from 12 PM to 1 PM.

In some embodiments, the device displays (624), on the display, a visual indication that the second graphical representation is a proposed new time for the calendar event. The visual indication efficiently notifies the user that the proposed new time has not been accepted as the new time for the event, reducing interaction with device that a user may perform to check whether the proposed new time has been accepted. As mentioned above, reducing interaction with the device conserves power and increases the time between battery charges and reduces wear-and-tear of the device. For example, in FIG. 5Q, the proposed canvas element 533B is displayed with cross-hatching (as opposed to a solid color for accepted events or parallel hatching for events the invitee has not responded to). As another example, in FIG. 5Q, the proposed canvas element 533B is displayed with the italic text “Proposed” in front of the event title of the new calendar event. In some embodiments, the device ceases display (626), on the display, of the visual indication in response to receiving, from the organizer, an indication that the proposed new time is accepted. For example, in FIG. 5R, in response to detecting the touch 581M on the organizer user interface 510 at the location of the accept affordance 549C of the inbox user interface 548, the organizer sends an indication to the invitee that the proposed new time is accepted. In response, as illustrated in FIG. 5S, the proposed canvas element 532B is displayed without a visual indication that the proposed canvas element is a proposed new time for the calendar event (e.g., as a solid color and without the italic text “Proposed” in front of the event title.

In some embodiments, in response to detecting the proposed new time input, the device ceases display (628), on the display, of the first graphical representation while displaying the second graphical representation. Thus, the user is efficiently notified that a new time has been proposed, reducing interaction with device that a user may perform to check whether the proposed new time has been accepted. As mentioned above, reducing interaction with the device conserves power and increases the time between battery charges and reduces wear-and-tear of the device/ For example, in FIGS. 5N-5M, in response to detecting the drag 581J, the invitee device 502 displays the proposed canvas element 533B, but ceases display of the new canvas element 532B.

In some embodiments, in response to detecting the proposed new time input, the device maintains display (630), on the display, of the first graphical representation while displaying the second graphical representation. Thus, the user is efficiently notified that the proposed new time has not been accepted as the new time for the event, reducing interaction with device that a user may perform to check whether the proposed new time has been accepted. As mentioned above, reducing interaction with the device conserves power and increases the time between battery charges and reduces wear-and-tear of the device. For example, in FIG. 5AA, the invitee user interface 520 includes both the new canvas element 532B and the proposed canvas element 533B. In some embodiments, the device maintains display (632) of the first graphical representation in response to detecting the accept invitation input (e.g., in block 606). In some embodiments, the device maintains display (634), on the display, of the first graphical representation in accordance with a determination that a show declined events setting is active. In some embodiments, declined events are shown when the show declined events setting is active and are hidden when the show declined events setting is not active. In some embodiments, graphical representations of declined events are visually distinguished from proposed events, accepted events, and events to which the invitee has not responded.

In some embodiments, in accordance with a determination that the calendar event was accepted prior to detecting the proposed new time input, the device maintains (636) display of the first graphical representation while displaying the second graphical representation and, in accordance with a determination that the calendar event was not accepted prior to detecting the proposed new time input, the device ceases display of the first graphical representation while displaying the second graphical representation. Thus, the user has an option to either display the canvas element at the original time or only at the proposed time. By providing the option to the user, interaction with the device is reduced based on the user's display preference, reducing interaction with device and thereby conversing power and increasing the time between battery charges and reducing wear-and-tear of the device. For example, in Figure AA, the invitee user interface 520 includes both the proposed canvas element 533B and the new canvas element 532B in accordance with detecting the touch 571N at the location of the accept affordance 547C of the inbox user interface 546 in FIG. 5T and, in FIG. 5Q, the invitee user interface 520 includes the proposed canvas element 533B but does not include the new canvas element 532B as not accept input was detected.

The device sends (638) a notification to the organizer including an indication of the proposed new time for the calendar event. Accordingly, the organizer is notified of the proposed new time with minimal interaction with the invitee device by the invitee. As mentioned above, reducing interaction with the device conserves power and increases the time between battery charges and reduces wear-and-tear of the device. In some embodiments, sending the notification is performed in response to detecting a confirmation input at a location of a confirmation affordance. In some embodiments, sending the notification is performed in response to detecting the proposed new time input without further user input.

In some embodiments, the device sends (640) a proposed calendar event to a calendar application of the organizer for display as a graphical representation of a proposed calendar event in the calendar application of the organizer. Such a graphical representation efficiently notifies the organizer that a new time has been proposed, reducing interaction with device that the organizer may perform in response to such a notification. As mentioned above, reducing interaction with the device conserves power and increases the time between battery charges and reduces wear-and-tear of the device. For example, in FIG. 5Q, the organizer user interface includes a proposed canvas element 533A in response to the invitee sending the notification as a proposed calendar event (in FIG. 5N).

In some embodiments, the device adds (642) an automatically-generated note to the calendar event including an indication of the proposed new time for the calendar event. Thus, in circumstances where the organizer device cannot receive calendar notifications, the note efficiently notifies the organizer that a new time has been proposed, reducing interaction with device that the organizer may perform in response to such a notification. By automatically generating the note, user interaction at the invitee device is also reduced. As mentioned above, reducing interaction with the device conserves power and increases the time between battery charges and reduces wear-and-tear of the device. For example, in FIG. 5O, the invitee device 502 detects a touch at the location of an add affordance 553C for adding to the calendar event an automatically-generated note (illustrated by the notes affordance 553A).

In some embodiments, the device sends (644) an automatically-generated e-mail message to an e-mail address of the organizer including an indication of the proposed new time for the calendar event. Thus, in circumstances where the organizer device cannot receive calendar notifications or added notes, the e-mail message efficiently notifies the organizer that a new time has been proposed, reducing interaction with device that the organizer may perform in response to such a notification. By automatically generating the e-mail message, user interaction at the invitee device is also reduced. As mentioned above, reducing interaction with the device conserves power and increases the time between battery charges and reduces wear-and-tear of the device. For example, in FIG. 5P, the invitee device 502 detects a touch at the location of a send affordance 555C for sending to the organizer an automatically-generated e-mail (illustrated by the notes affordance 555A).

In some embodiments, the notification includes (646) an indication that the invitee has declined the invitation for the calendar event. For example, in FIG. 5AD, the organizer user interface 510 includes a second proposed canvas element 533C in response to the second invitee sending a notification to the organizer including an indication of a second proposed new time for the calendar event. Further, the organizer user interface 510 indicates, in the invitee listing 567C, that the second invitee has declined the invitation to the calendar event.

In some embodiments, sending the notification to the organizer does not include (648) sending the notification to other invitees of the calendar event. By sending the notification to the organizer without sending the notification to other invitees, user interaction at the devices of the other invitees is reduced (at least until the time of the calendar event is changed). Reducing interaction with the device conserves power and increases the time between battery charges and reduces wear-and-tear of the device. For example, in FIG. 5AD, the organizer user interface 510 includes a second proposed canvas element 533C in response to the second invitee sending a notification to the organizer including an indication of a second proposed new time for the calendar event, but the invitee user interface 520 does not include any indication that a notification was received from the second invitee (e.g., does not include a second proposed canvas element or a changed inbox affordance).

In some embodiments, the notification is sent (650) in response to an input dragging the first graphical representation to a location of the calendar user interface corresponding to the proposed new time. Thus, the notification is sent automatically without further user input so that sending a proposed new time is as intuitive as dragging a canvas element to a new location in the user's calendar. Further, as the notification is sent automatically, user interaction at the invitee device is reduced, conversing power and reducing wear-and-tear of the device. For example, in FIGS. 5L-5M, the invitee device 502 detects a drag 581J dragging the new canvas element 532B to a location of the calendar user interface corresponding to the proposed new time. Although FIG. 5N illustrates a confirmation user interface 550, in some embodiments, as described above, the notification is sent in response to detecting the input without user interaction with a confirmation user interface.

In some embodiments, while displaying, on the display, the second graphical representation, the device receives (652) an update to the event from the organizer including an indication of a new time for the calendar event. For example, in FIG. 5AE, the organizer device 501 detects a touch 581X at a location of the accept affordance 549D and, in response, sets the time of the new calendar event to the proposed new time and sends an update to the event to the invitee (and the second invitee). In some embodiments, in response to receiving the update, the device ceases display (654), on the display of the second graphical representation and displays, on the display, a third graphical representation of the calendar event at a location of the calendar user interface corresponding to the new time for the calendar event. By ceasing display of the second graphical representation, a user is less likely to be confused as to the confirmed time of the calendar event and is less likely to interact with the device to determine the confirmed time of the calendar event. Reducing interaction with the device conserves power and increases the time between battery charges and reduces wear-and-tear of the device. For example, in FIG. 5AF, the invitee user interface ceases display of the proposed canvas element 533B as a proposed event and displays the proposed canvas element 533B as a canvas element corresponding to the new calendar event at the new time. As another example, a second invitee user interface of a second invitee device displays a canvas element at the second proposed new time and, in response to receiving the update from the organizer, ceases display of the canvas element at the second proposed new time of the second invitee and displays a canvas element at the new time (e.g., the accepted proposed new time of the first invitee).

It should be understood that the particular order in which the operations in FIGS. 6A-6D have been described is merely example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 600 described above with respect to FIGS. 6A-6D. For example, the inputs, affordances, and user interfaces described above with reference to method 600 optionally have one or more of the characteristics of the inputs, affordances, and user interfaces described herein with reference to other methods described herein (e.g., method 700). For brevity, these details are not repeated here.

FIGS. 7A-7C illustrate a flow diagram of a method 700 of changing the time of a calendar event in accordance with some embodiments. The method 700 is performed at an electronic device (e.g., the portable multifunction device 100 in FIG. 1A, the device 300 in FIG. 3, or the organizer device 501 of FIG. 5) with a display and a touch-sensitive surface. In some embodiments, the display is a touch-screen display and the touch-sensitive surface is on or integrated with the display. In some embodiments, the display is separate from the touch-sensitive surface. Some operations in method 700 are, optionally, combined and/or the order of some operations is, optionally, changed.

As described below, the method 700 provides an intuitive way to change the time of a calendar event. The method reduces the cognitive burden on a user when changing the time of a calendar event, thereby creating a more efficient human-machine interface. For battery-operated electronic devices, enabling a user to change the time of a calendar event faster and more efficiently conserves power and increases the time between battery charges.

The device sends (702), to an invitee, an invitation for a calendar event. For example, in FIG. 5I, the organizer device 501, in response to detecting the touch 581H at the location of the accept affordance 541B sends an invitation for the new calendar event to the first invitee (“Bob”) and the second invitee (“Evan”).

The device displays (704), on the display, a calendar user interface including a first graphical representation of the calendar event displayed at a location of the calendar user interface corresponding to a time of the calendar event. For example, in FIG. 5J, the organizer user interface 510 includes the new canvas element 532A displayed at a location of the calendar user interface corresponding to the time of the new calendar event.

The device receives (706), from the invitee, a notification including an indication of a proposed new time for the calendar event. For example, in FIG. 5R, the organizer user interface 510 includes an inbox user interface 548 that indicates that a notification including an indication of a proposed new time for the calendar event has been received.

In response to receiving the notification, the device displays (708), on the display, a proposed new time indicator in association with the first graphical representation. Thus, the organizer is quickly and efficiently notified that a new time for the calendar event has been proposed, reducing interaction with the device to schedule the calendar event at a time that all potential participants can attend the event. Reducing interaction with the device conserves power and increases the time between battery charges and reduces wear-and-tear of the device. For example, in FIG. 5R, the new canvas element 532A of the organizer user interface 510 includes a proposed new time icon 535 displayed within the first graphical representation. As another example, in FIG. 5AD, the organizer user interface 510 includes an invitee listing 567C including proposed new time indicators displayed in association with response statuses of the invitees. Thus, in some embodiments, the proposed new time indicator includes (710) text or an icon displayed within the first graphical representation. In some embodiments, the proposed new time indicator is displayed (712) in association with a response status of the invitee.

In some embodiments, in response to receiving the notification, the device displays (714), on the display, a second graphical representation of the calendar event at a location of the calendar user interface corresponding to the proposed new time. Thus, the organizer is quickly and efficiently notified of the proposed new time, reducing interaction with the device as the organizer attempts to ascertain this information. Reducing interaction with the device conserves power and increases the time between battery charges and reduces wear-and-tear of the device. For example, in FIG. 5Q, the organizer user interface 510 includes a proposed canvas element 533A displayed at a location of the calendar user interface corresponding to the proposed new time. In some embodiments, the device displays (716), on the display, a visual indication that the second graphical representation is a proposed time for the calendar event. For example, in FIG. 5Q, the proposed canvas element 533A is displayed with cross-hatching (as opposed to a solid color for accepted events). As another example, in FIG. 5Q, the proposed canvas element 533A is displayed with the italic text “Proposed” in front of the event title of the new calendar event.

In some embodiments, the device displays (718), on the display, a notification response user interface including options to accept the proposed new time, reply to the invitee, or ignore the notification. Thus, the organizer can quickly and efficiently respond to the notification, reducing user interaction with the device. Reducing interaction with the device conserves power and increases the time between battery charges and reduces wear-and-tear of the device. For example, in FIG. 5R, the organizer user interface 510 includes an inbox user interface 548 including an accept affordance 549C for sending an accept response to the invitee for proposed new time for the new calendar event, a reply affordance 549D for sending a reply to the invitee in response to the proposed new time for the new calendar event, an ignore affordance 549E for ignoring the notification.

In some embodiments, the device detects (720), via the input device, an event interaction input interacting with the first graphical representation. For example, in FIG. 5AB, the organizer device 501 detects a touch 581U at a location of the new canvas element 532A.

In some embodiments, in response to detecting the event interaction input, the device displays (722), on the display, an event details user interface. For example, in FIG. 5AC, in response to detecting the touch 581U at the location of the new canvas element 532A, the organizer user interface 510 includes an event details user interface 544. In some embodiments, the event details user interface includes (724) one or more indications of event details of the calendar event including a title of the calendar event, the time of the calendar event, and a list of invitees of the calendar event. For example, in FIG. 5AC, the event details user interface 644 includes descriptive text 545C including indications of the event tile of the new calendar event (e.g., “Lunch) and the time of the new calendar event (e.g., Tuesday, May 24, 2016, from 12 PM to 1 PM). In FIG. 5AD, the invitees user interface 566 (part of the event details user interface 544) includes an invitee listing 567C listing the invitees of the new calendar event. In some embodiments, the list of invites includes (726) an indication of the proposed new time displayed in association with an indication of the invitee. Thus, an organizer is quickly and efficiently notified as to a proposed new time of one or more of the invitees, reducing interaction with the device. Reducing interaction with the device conserves power and increases the time between battery charges and reduces wear-and-tear of the device. For example, in FIG. 5AD, the invitee listing 567C includes an indication of the proposed new time (e.g., Thursday, May 26, from 12 PM to 1 PM) displayed in association with an indication of the first invitee (e.g., “Bob”).

In some embodiments, the device detects (728), via the input device, a new time input indicative of a new time for the calendar event. For example, in some embodiments, the device detects (730), via the input device, an input accepting the proposed new time. For example, in FIG. 5AE, the organizer device 501 detects a touch 581X at a location of the accept affordance 549C of the inbox user interface 548 accepting the proposed new time of the first invitee.

In some embodiments, in response to detecting the new time input, the device sends (732) a notification to at least the invitee (and, in some embodiments, other invitees of the calendar event) including an indication of the new time of the calendar event. For example, in FIG. 5AF, in response to such a notification being sent to the invitee, the invitee user interface displays the proposed canvas element 533B without the visual indication that the time of the canvas element is a proposed time of the new calendar event.

In some embodiments, in response to detecting the new time input, the device ceases display (734), on the display, of the proposed new time indicator. For example, in FIG. 5AF, the new canvas element 532A no longer includes a proposed new time icon 535. Thus, the organizer is less likely to be confused as to the actual time of the event and need not interact with the device to ascertain such information. Reducing interaction with the device conserves power and increases the time between battery charges and reduces wear-and-tear of the device.

In some embodiments, the device sends (736), to a second invitee, a second invitation for the calendar event. For example, in FIG. 5F, the invitees user interface 542 of the organizer user interface 510 indicates that invitation are later sent to both the first invitee and the second invitee.

In some embodiments, the device receives (738), from the second invitee, a second notification including an indication of a second proposed new time for the calendar event. For example, in FIG. 5AB, the organizer user interface 510 includes a second proposed canvas element 533C in response to receiving a second notification including an indication of a second proposed new time for the calendar event. In some embodiments, the proposed new time and second proposed new time are synchronized (740) between different devices of the organizer (e.g., the organizer device 501 and at least one other device of the organizer).

In some embodiments, in response to receiving the second notification, the device displays (742), on the display, a third graphical representation of the calendar event at a location of the calendar user interface corresponding to the second proposed new time. Thus, an organizer is quickly and efficiently notified as to a proposed new time of multiple invitees, reducing interaction with the device. Reducing interaction with the device conserves power and increases the time between battery charges and reduces wear-and-tear of the device. For example, in FIG. 5AB, the organizer user interface 510 includes the second proposed canvas element 533C displayed at a location of the calendar user interface corresponding to the second proposed new time (e.g., Tuesday, May 24, 2016, from 1 PM to 2 PM).

In some embodiments, the device displays, on the display (744), indications of the proposed new time and the second proposed new time within an event details user interface in association with respective response statuses of the invitee and the second invitee. Thus, an organizer is quickly and efficiently notified as to a proposed new time of multiple invitees, reducing interaction with the device. Reducing interaction with the device conserves power and increases the time between battery charges and reduces wear-and-tear of the device. For example, in FIG. 5AD, the invitee listing 567C includes an indication of the proposed new time (e.g., Thursday, May 26, from 12 PM to 1 PM) displayed in association with an indication of the first invitee (e.g., “Bob”) and his response status (e.g., “Accepted”). The invitee listing 567C also includes an indication of the second proposed new time (e.g., Tuesday, May 24, from 1 PM to 2 PM) displayed in association with an indication of the second invitee (e.g., “Evan”) and his response status (e.g., “Declined”).

In some embodiments, the device detects (746), via the input device, an input accepting a particular proposed new time for the calendar event. For example, in FIG. 5AE, the organizer device 501 detects a touch 581X at a location of the accept affordance 549C of the inbox user interface 548 accepting the proposed new time of the first invitee. In some embodiments, in accordance with a determination that the particular proposed new time is the proposed new time, the device declines (748) the second proposed new time and, in accordance with a determination that the particular proposed new time is the second proposed new time, the device declines the proposed new time. Thus, the organizer need not explicitly decline other proposed new times when a new proposed time is accepted, reducing interaction with the device. Reducing interaction with the device conserves power and increases the time between battery charges and reduces wear-and-tear of the device. For example, in FIG. 5AF, in accordance with a determination that the touch 581X was detected accepting the proposed new time of the first invitee, the second proposed canvas element 533C is no longer displayed.

It should be understood that the particular order in which the operations in FIGS. 7A-7C have been described is merely example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 600) are also applicable in an analogous manner to method 700 described above with respect to FIGS. 7A-7C. For example, the inputs, affordances, and user interfaces described above with reference to method 700 optionally have one or more of the characteristics of the inputs, affordances, and user interfaces described herein with reference to other methods described herein (e.g., method 600). For brevity, these details are not repeated here.

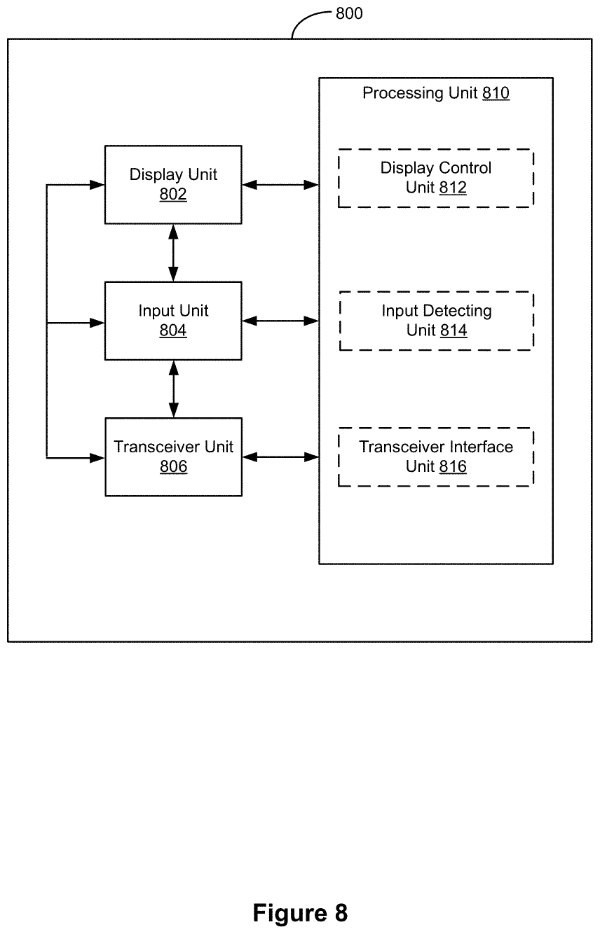

In accordance with some embodiments, FIG. 8 shows a functional block diagram of an electronic device 800 configured in accordance with the principles of the various described embodiments. The functional blocks of the device are, optionally, implemented by hardware, software, firmware, or a combination thereof to carry out the principles of the various described embodiments. It is understood by persons of skill in the art that the functional blocks described in FIG. 8 are, optionally, combined or separated into sub-blocks to implement the principles of the various described embodiments. Therefore, the description herein optionally supports any possible combination or separation or further definition of the functional blocks described herein.

As shown in FIG. 8, an electronic device 800 includes a display unit 802 configured to display a user interface, an input unit 804 configured to receive inputs, a transceiver unit 806 configured to send and receive data over a communications network, and a processing unit 810 coupled with the display unit 802, the input unit 804 and the transceiver unit 806. In some embodiments, the processing unit 810 includes: a display control unit 812, an input detecting unit 814, and a transceiver interface unit 816.

The processing unit 810 is configured to receive (e.g., with the transceiver interface unit 816), from an organizer via the transceiver unit 806, an invitation for a calendar event. The processing unit 810 his configured to display (e.g., with the display control unit 812), on the display unit 802, a calendar user interface including a first graphical representation of the calendar event displayed at a location of the calendar user interface corresponding to a time of the calendar event.

In some embodiments, the processing unit 810 is configure to detect (e.g., with the input detecting unit 814), via the input unit 804, an accept invitation input accepting the invitation for the calendar event. In some embodiments, the processing unit 810 is configured to detect (e.g., with the input detecting unit 814), via the input unit 804, an event interaction input interacting with the first graphical representation. In some embodiments, the processing device 810 is configured to, in response to detecting the event interaction input, display (e.g., with the display control unit 812), on the display unit 802, an event details user interface including an option to propose a new time for the calendar event. In some embodiments, the event details user interface includes, in association with the option to propose a new time for the calendar event, suggested proposed new times based on an availability of one or more participants of the calendar event. In some embodiments, the event details user interface includes one or more indications of event details of the calendar event including a title of the calendar event, the time of the calendar event, and a list of invitees of the calendar event. In some embodiments, the event details user interface includes an option to send invitations for the calendar event to other users.

The processing unit 810 detects (e.g., with the input detecting unit 814), via the input unit 804, a proposed new time input indicative of a proposed new time for the calendar event. In some embodiments, the processing unit detects the proposed new time input by detecting (e.g., with the input detecting unit 814), via the input unit 804, an input dragging the first graphical representation to a location of the calendar user interface corresponding to the proposed new time.

In response to detecting the proposed new time input, the processing unit 810 displays (e.g., with the display control unit 812), on the display unit 802, a second graphical representation of the calendar event at a location of the calendar user interface corresponding to the proposed new time. In some embodiments, the processing unit 810 displays the second graphical representation with a visual indication that the second graphical representation is a proposed new time for the calendar event. In some embodiments, the processing unit 810 ceases display (e.g., with the display control unit 812), on the display 802, of the visual indication in response to receiving (e.g., with the transceiver interface unit 816), from the organizer via the transceiver unit 806, an indication that the proposed new time is accepted.

In some embodiments, in response to detecting the proposed new time input, the processing unit 810 ceases display (e.g., with the display control unit 812), on the display unit 802, of the first graphical representation while displaying the second graphical representation. In some embodiments, in response to detecting the proposed new time input, the processing unit 810 maintains display (e.g., with the display control unit 812), on the display unit 802, of the first graphical representation while displaying the second graphical representation. For example, in some embodiments, the processing unit 810 maintains display, on the display unit, of the first graphical representation in response to detecting an accept invitation input. As another example, in some embodiments, the processing unit 810 maintains display, on the display unit, of the first graphical representation in accordance with a determination that a show declined events setting is active. In some embodiments, in accordance with a determination that the calendar event was accepted prior to detecting the proposed new time input, the processing unit 810 maintains display (e.g., with the display control unit 812) of the first graphical representation while displaying the second graphical representation and, in accordance with a determination that the calendar event was not accepted prior to detecting the proposed new time input, ceases display (e.g., with the display control unit 812) of the first graphical representation while displaying the second graphical representation.

The processing unit 810 sends (e.g., with the transceiver interface unit 816), via the transceiver unit 806, a notification to the organizer including an indication of the proposed new time for the calendar event. In some embodiments, the processing unit 810 sends the notification by sending a proposed calendar event to a calendar application of the organizer for display as a graphical representation of a proposed calendar event in the calendar application of the organizer. In some embodiments, the processing unit 810 sends the notification by adding an automatically-generated note to the calendar event including an indication of the proposed new time for the calendar event. In some embodiments, the processing unit 810 sends the notification by sending an automatically-generated e-mail message to an e-mail address of the organizer including an indication of the proposed new time for the calendar event.

In some embodiments, the notification includes an indication that the invitee has declined the invitation for the calendar event. In some embodiments, the processing unit 810 sends the notification to the organizer without sending the notification to other invitees of the calendar event. In some embodiments, the processing unit 810 sends the notification in response to an input dragging the first graphical representation to a location of the calendar user interface corresponding to the proposed new time.

In some embodiments, while displaying (e.g., with the display control unit 812), on the display unit 802, the second graphical representation, the processing unit 810 receives (e.g., with the transceiver interface unit 816), via the transceiver unit 806, an update to the event from the organizer including an indication of a new time for the calendar event. In some embodiments, in response to receiving the update to the event, the processing unit 810 ceases display (e.g., with the display control unit 812), on the display unit 802, of the second graphical representation and displays (e.g., with the display control unit 812), on the display unit 802, a third graphical representation of the calendar event at a location of the calendar user interface corresponding to the new time for the calendar event.

The operations in the information processing methods described above are, optionally implemented by running one or more functional modules in information processing apparatus such as general purpose processors (e.g., as described above with respect to FIGS. 1A and 3) or application specific chips.

The operations described above with reference to FIGS. 6A-6D are, optionally, implemented by components depicted in FIGS. 1A-1B or FIG. 8. For example, receiving operation 602, displaying operation 604, detecting operation 618, displaying operation 622, and sending operation 638 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

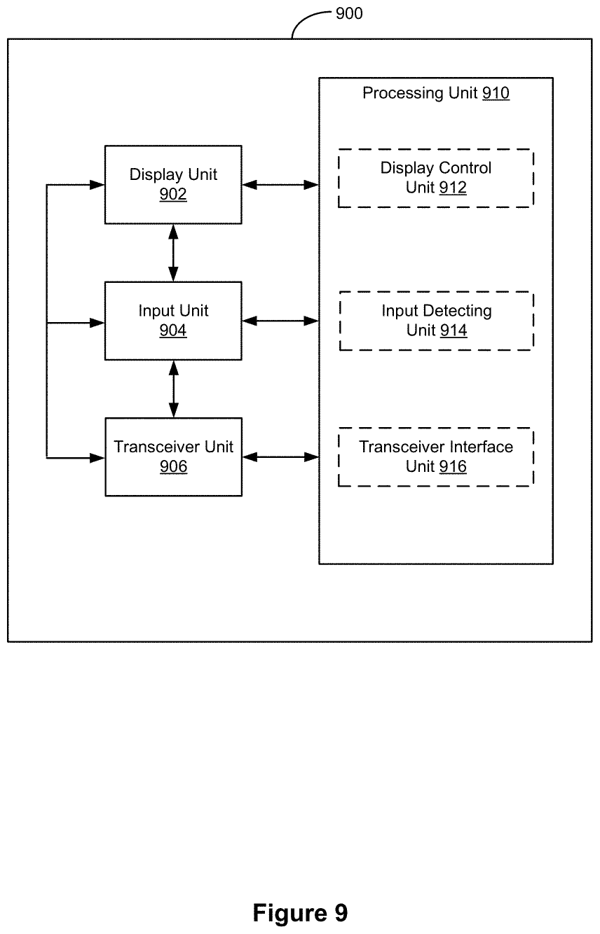

In accordance with some embodiments, FIG. 9 shows a functional block diagram of an electronic device 900 configured in accordance with the principles of the various described embodiments. The functional blocks of the device are, optionally, implemented by hardware, software, firmware, or a combination thereof to carry out the principles of the various described embodiments. It is understood by persons of skill in the art that the functional blocks described in FIG. 9 are, optionally, combined or separated into sub-blocks to implement the principles of the various described embodiments. Therefore, the description herein optionally supports any possible combination or separation or further definition of the functional blocks described herein.

As shown in FIG. 9, an electronic device 900 includes a display unit 902 configured to display a user interface, an input unit 904 configured to receive inputs, a transceiver unit 906 configured to send and receive data over a communications network, and a processing unit 910 coupled with the display unit 902, the input unit 904, and the transceiver unit 906. In some embodiments, the processing unit 910 includes: a display control unit 912, an input detecting unit 914, and a transceiver interface unit 916.

The processing device 910 is configured to send (e.g., with the transceiver interface unit 916), via the transceiver unit 906, to an invitee, an invitation for a calendar event. The processing device 910 is configured to display (e.g., with the display control unit 912), on the display unit 902, a calendar user interface including a first graphical representation of the calendar event displayed at a location of the calendar user interface corresponding to a time of the calendar event. The processing device 910 is configured to receive (e.g., with the transceiver interface unit 916), via the transceiver unit 906, from the invitee, a notification including an indication of a proposed new time for the calendar event. In response to receiving the notification, the processing unit 910 is configured to display (e.g., with the display control unit 912), on the display unit 902, a proposed new time indicator in association with the first graphical representation. In some embodiments, the proposed new time indicator includes text or an icon displayed within the first graphical representation. In some embodiments, the proposed new time indicator is displayed in association with a response status of the invitee.

In some embodiments, in response to receiving the notification, the processing unit 910 is configured to display (e.g., with the display control unit 912), on the display unit 902, a second graphical representation of the calendar event at a location of the calendar user interface corresponding to the proposed new time. In some embodiments, the processing unit 910 is configured to display the second graphical representation with a visual indication that the second graphical representation is a proposed time for the calendar event.

In some embodiments, in response to receiving the notification, the processing unit 910 is configured to display (e.g., with the display control unit 912), on the display unit 902, a notification response user interface including options to accept the proposed new time, reply to the invitee, or ignore the notification.

In some embodiments, the processing unit 910 is configured to detect (e.g., with the input detecting unit 914), via the input unit 904, an event interaction input interacting with the first graphical representation. In some embodiments, in response to detecting the event interaction input, the processing unit 910 is configured to display (e.g., with the display control unit 912), on the display unit 902, an event details user interface. In some embodiments, event details user interface includes one or more indications of event details of the calendar event including a title of the calendar event, the time of the calendar event, and a list of invitees of the calendar event. In some embodiments, the list of invitees includes an indication of the proposed new time displayed in association with an indication of the invitee.

In some embodiments, the processing unit 910 is configured to detect (e.g., with the input detecting unit 914), via the input unit 904, a new time input indicative of a new time for the calendar event. In some embodiments, the processing unit 910 is configured to detect the new time input by detecting (e.g., with the input detecting unit 914), via the input unit 904, an input accepting the proposed new time. In some embodiments, the processing unit 910 is configured to, in response to detecting the new time input, send (e.g., with the transceiver interface unit 916), via the transceiver unit 906, a notification at least to the invitee including an indication of the new time of the calendar event. In some embodiments, in response to detecting the new time input, the processing unit 910 is configured to cease display (e.g., with the display control unit 912), on the display unit 902, of the proposed new time indicator.

In some embodiments, the processing unit 910 is configured to send (e.g., with the transceiver interface unit 916), via the transceiver unit 906, to a second invitee, a second invitation for the calendar event. In some embodiments, processing unit 910 is configured to receive (e.g., with the transceiver interface unit 916), via the transceiver unit 906, a second notification including an indication of a second proposed new time for the calendar event. In some embodiments, the proposed new time and the second proposed new time are synchronized between different devices of the organizer.

In some embodiments, in response to receiving the second notification, the processing unit 910 is configured to display (e.g., with the display control unit 912), on the display unit 902, a third graphical representation of the calendar event at a location of the calendar user interface corresponding to the second proposed new time.

In some embodiments, the processing unit 910 is configured to detect (e.g., with the input detecting unit 914), via the input unit 904, an input accepting a particular proposed new time for the calendar event. In some embodiments, in response to detecting the input accepting a particular proposed new time for the calendar event, the processing unit 910 is configured to, in accordance with a determination that the particular proposed new time is the proposed new time, decline (e.g., with the transceiver interface unit 916) the second proposed new time and, in accordance with a determination that the particular proposed new time is the second proposed new time, decline (e.g., with the transceiver interface unit 916) the proposed new time.

The operations in the information processing methods described above are, optionally implemented by running one or more functional modules in information processing apparatus such as general purpose processors (e.g., as described above with respect to FIGS. 1A and 3) or application specific chips.

The operations described above with reference to FIGS. 7A-7C are, optionally, implemented by components depicted in FIGS. 1A-1B or FIG. 9. For example, sending operation 702, displaying operation 704, receiving operation 706, and displaying operation 708 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at a device with one or more processors, non-transitory memory, an input device, and a display:
sending, to an invitee, an invitation for a calendar event;
displaying, on the display, a calendar user interface including a first graphical representation of the calendar event displayed at a location of the calendar user interface corresponding to a time of the calendar event;
receiving, from the invitee, a notification including an indication of a proposed new time for the calendar event; and
in response to receiving the notification, displaying, on the display, a proposed new time indicator in association with the first graphical representation.

2. The method of claim 1, wherein the proposed new time indicator includes text or an icon displayed within the first graphical representation.

3. The method of claim 1, wherein the proposed new time indicator is displayed in association with a response status of the invitee.

4. The method of claim 1, further comprising, in response to receiving the notification, displaying, on the display, a second graphical representation of the calendar event at a location of the calendar user interface corresponding to the proposed new time.

5. The method of claim 4, wherein displaying the second graphical representation including displaying a visual indication that the second graphical representation is displayed at a location corresponding to a proposed time for the calendar event.

6. The method of claim 1, further comprising:
detecting, via the input device, an event interaction input interacting with the first graphical representation; and
in response to detecting the event interaction input, displaying an event details user interface.

7. The method of claim 6, wherein the event details user interface includes one or more indications of event details of the calendar event including a title of the calendar event, the time of the calendar event, and a list of invitees of the calendar event.

8. The method of claim 7, wherein the list of invitees includes an indication of the proposed new time displayed in association with an indication of the invitee.

9. The method of claim 1, further comprising, displaying, on the display, a notification response user interface including options to accept the proposed new time, reply to the invitee, or ignore the notification.

10. The method of claim 1, further comprising:
detecting, via the input device, a new time input indicative of a new time for the calendar event;
in response to detecting the new time input:
displaying, on the display, the first graphical representation at a location of the calendar user interface corresponding to the new time; and
sending a notification to at least the invitee including an indication of the new time of the calendar event.

11. The method of claim 10, wherein detecting the new time input includes detecting, via the input device, an input accepting the proposed new time.

12. The method of claim 10, further comprising, in response to detecting the new time input, ceasing display, on the display, of the proposed new time indicator.

13. The method of claim 1, further comprising:
sending, to a second invitee, a second invitation for the calendar event; and
receiving, from the second invitee, a second notification including an indication of a second proposed new time for the calendar event.

14. The method of claim 13, further comprising, in response to receiving the second notification, displaying, on the display, a third graphical representation of the calendar event at a location of the calendar user interface corresponding to the second proposed new time.

15. The method of claim 13, further comprising:
detecting, via the input device, an input accepting a particular proposed new time for the event; and
in response to detecting the input accepting the particular proposed new time for the event:
in accordance with a determination that the particular proposed new time is the first proposed new time, declining the second proposed new time; and
in accordance with a determination that the particular proposed new time is the second proposed new time, declining the first proposed new time.

16. The method of claim 13, further comprising displaying, on the display, indications of the proposed new time and the second proposed new time within an event details user interface in association with respective response statuses of the invitee and the second invitee.

17. The method of claim 13, wherein the proposed new time and the second proposed new time are synchronized between different devices of the organizer.

18. An electronic device, comprising:
a display;
an input device;
one or more processors;
non-transitory memory; and
one or more programs, wherein the one or more programs are stored in the memory and configured to be executed by the one or more processors, the one or more programs including instructions for:
sending, to an invitee, an invitation for a calendar event;
displaying, on the display, a calendar user interface including a first graphical representation of the calendar event displayed at a location of the calendar user interface corresponding to a time of the calendar event;
receiving, from the invitee, a notification including an indication of a proposed new time for the calendar event; and
in response to receiving the notification, displaying, on the display, a proposed new time indicator in association with the first graphical representation.

19. A non-transitory computer readable storage medium storing one or more programs, the one or more programs comprising instructions, which, when executed by an electronic device with a display, and an input device, cause the electronic device to:
send, to an invitee, an invitation for a calendar event;
display, on the display, a calendar user interface including a first graphical representation of the calendar event displayed at a location of the calendar user interface corresponding to a time of the calendar event;
receive, from the invitee, a notification including an indication of a proposed new time for the calendar event; and
in response to receiving the notification, display, on the display, a proposed new time indicator in association with the first graphical representation.

20. The non-transitory computer readable storage medium of claim 19, wherein the proposed new time indicator includes text or an icon displayed within the first graphical representation.
